(19) United States
(12) Patent Application Publication
(10) Pub. No.: US 2007/0259107 A1
(43) Pub. Date: Nov. 8, 2007

(54) Method and Apparatus for Coating Plastic Optical Fiber with Resin

(75) Inventors: Rei Miyasaka, Shizuoka (JP); Tadahiro Kegasawa, Shizuoka (JP); Yoshisada Nakamura, Shizuoka (JP); Takanori Sato, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku, Tokyo (JP)

(21) Appl. No.: 11/660,766

(22) PCT Filed: Aug. 19, 2005
(86) PCT No.: PCT/JP05/15492

§ 371 Date: Feb. 22, 2007

(30) Foreign Application Priority Data
Aug. 23, 2004 (JP) 2004-242616

(51) Int. Cl. B05D 5/06

(52) U.S. Cl. 427/163.2; 118/254

(57) ABSTRACT

In a coating apparatus, low density polyethylene (122) is flowed in the resin passage (123, 124) between a die (120) and a nipple (121) to form an optical fiber strand having a protective layer (129) on the POF (14). The die (120) and the nipple (121) satisfy the following conditions:
D≦TA≦1.3×D
TA≦L≦4×TA
0.7×TA≦TB1≦1.3×TA
(D1+10) μm≦TB2≦(D1+300 ) μm
TA≦d≦2×TA
in which TA (μm) indicates the diameter of the die (120), TB1 (μm) indicates the diameter of the nipple (121), TB2 (μm) is the inner diameter of the nipple (121), D1 (μm) is the diameter of the POF (14), D (μm) is the diameter of the optical fiber strand, and d (μm) is the clearance between the die (120) and the nipple (121).

### TECHNICAL FIELD

The present invention relates to a method and an apparatus for coating a plastic optical fiber with resin.

### Background Art

Because of large transmission loss compared with a glass optical fiber, a plastic optical fiber is not suitable in transmitting optical signals for a long distance. Despite larger transmission loss than glass optical fiber, the plastic optical fiber has various merits, such as facility in connection due to a large diameter, facility in fiber terminal process, non-necessity for core alignment with high precision, cost reduction of the connecter, low danger to prick into human body, easy construction, high resistance to vibration and low price. Accordingly, it is planned to utilize the plastic optical fiber not only as household and automobile purposes but as a short-distance, high-capacity cable such as inner wirings for high-speed data processing device and a digital video interface (DVI) link.

The plastic optical fiber (hereinafter referred to as “POF”) is composed of a core part whose main component is an organic compound of polymer matrix, and a clad part composed of a material having smaller refractivity than the core part. The plastic optical fiber is produced by forming a fiber including the core part and the clad part at the same time by drawing or extruding a pre-polymer. It is also possible to produce the plastic optical fiber by forming an optical fiber base material (hereinafter referred to “preform”), and melt-drawing the preform.

The POF with a desirable diameter is formed by melt-drawing the preform at a temperature from 180° C. to 260° C. During the melt-drawing process, the lower end of the preform is drawn to extend the preform while the preform is heated in a cylindrical heating furnace with an electric heater. For instance, after holding the preform, the preform is slowly moved down into the heating furnace, and the preform is melted in the heating furnace. After the preform is softened enough that the molten part of the preform is partially moved down due to its gravity, the leading end of the molten preform is drawn and hooked to a drawing roller, so that the preform is continuously extended to manufacture the POF (see Japanese Laid-Open Patent Publication (JP-A) No. 11-337781, for example).

The bare POF manufacture in this way is used for some limited purpose, but the POF applied to various purposes is coated for protection (forming a protective layer, for instance), or kept in a tube with an inner diameter enough for inserting the POF. Protecting the POF can prevent flaw, damage, structural irregularity (such as micro-bending), and decrease in optical properties in handling the POF or in using the POF in a bad environment. The POF coated with the protective layer is referred to as a plastic optical fiber strand, a plastic optical fiber code, and a plastic optical fiber cable. For the purpose of simplification, the plastic optical fiber and the plastic optical fiber code are hereinafter referred to as an optical fiber strand, and the plastic optical fiber cable is hereinafter referred to as an optical fiber cable. Examples of the materials to protect the POF are thermoplastic resin, such as polyvinyl chloride, Nylon (Trademark), polypropylene, polyester, polyethylene, ethylene vinyl acetate copolymer, ethylene ethylacrylate copolymer (EEA). It is also possible to apply a thermoplastic resin other than those listed above. Conventionally, as described in Japanese Laid-Open Patent Publication (JP-A) No. 11-337781, the protective layer is formed on the POF by passing the POF through a chamber containing molten or liquid polymer, and by solidifying the polymer on the POF after passing the chamber.

The protection layer is formed by use of a coating apparatus having a die and a nipple. The coating apparatus disclosed in JP-A No. 4-254441, for example, can decrease variation in the outer diameter of the POF, and can prevent breakage of the POF even if the coating layer is continuously formed for a long period. The coating apparatus described in JP-A No. 10-194793 makes it possible to prevent overflow of the thermoplastic resin out of the nipple during the coating process, and thus possible to form the protective layer with uniform thickness. Moreover, the coating method described in JP-A No. 2002-18926 can form the protective layer with a uniform thickness.

However, since the POF itself is a plastic (for example, polymethyl methacrylate; PMMA), the properties of the POF (for example, transmission loss) tend to become worse because of the thermal energy to melt the protective layer resin (normally the thermoplastic resin) at a temperature of 150° C. or higher. Even if the temperature is within the range not to affect the transmission loss, the shape of the mold (the die and the nipple) for passing the molten resin will cause unnecessary tension to the POF and thus increase the transmission loss. As for the coating method for the POF, there are pressurization type and tube type. In the pressurization type coating, the coating resin is contacted to the POF under a pressurized condition, so the protective layer is tightly coated on the POF, compared with the tube type coating. However, the pressurization type coating directly transfers heat from the coating resin to the POF. Thus, increase in the transmission loss caused by deformation (stretch, for example) of the POF becomes a serious problem.

In the coating method described in JP-A No. 4-254441, it is possible to decrease fluctuation in the diameter of the protective layer and thus to obtain a plastic optical fiber strand (optical fiber strand) with excellent appearance by solving the problem of overflowing the thermoplastic resin out of the nipple. This coating method, however, does not deal with the problem of deterioration in the transmission loss caused by thermal damage to the POF during the coating process. In addition, the coating method and device described in JP-A Nos. 10-194793 and 2002-18926 do not address the problem of thermal damage to the POF, although the technique in these references can improve accuracy and stability in size of the coating layer.

In coating the protective layer on the POF, stress is distributed in the protective layer and thus the refractive index in the manufactured POF is deviated. As a result, the transmission loss will increase because the transmission light through the POF is scattered. Moreover, when external air is introduced in forming the protective layer on the POF, the interface between the POF and the protective layer becomes uneven, and thus the transmission loss will increase.

In the pressurization coating to coat the molten coating material on the POF, thermal damage to the POF makes it difficult to coat the coating material without decreasing the optical properties. Especially, the thermal damage becomes serious in forming a thick coating layer having the thickness 400 μm to 1000 μm, so two-step method to carry out the coating process twice is widely applied. But such coating method will increase the processes for coating the protective layer. Moreover, the necessity to select the suitable combination of the coating materials narrows the range of the coating materials to be selected.

An object of the present invention is to provide a method and an apparatus for coating a plastic optical fiber with a protective layer having a thickness of 100 μm to 1000 μm, and for keeping the optical properties of the plastic optical fiber.

### DISCLOSURE OF INVENTION

The pressurization type coating can coat a thermoplastic resin tightly on a plastic optical fiber because of the coating process under a pressurized condition. But the material of the core part of the plastic optical fiber, such as PMMA, is sensitive to heat, so the transmission loss of the plastic optical fiber tends to increase due to the heat directly transferred from the molten resin while the molten resin is coated. Moreover, in the event of manufacturing a graded index type plastic optical fiber having plasticized component, the transmission loss largely increases due to the distribution in the glass transition temperature in the core part is affected by heat.

The inventors of the present invention examined the condition of the plastic optical fiber during the coating process, and have found that the optical fiber is extended by the heat of the molten resin and thus the optical fiber has irregularity to cause scattering loss at the interface between the core and the clad. The extension of the optical fiber is largely affected by the tension to the optical fiber during the coating process, rather than the temperature of the molten resin. The tension to the plastic optical fiber affected not only by the set tension of the optical fiber feeder but by the shape of the mold (die and nipple) attached to the tip of the extruder of the molten resin. Thus, it is possible to decrease the tension to the fiber by adjusting the shape of the die and the nipple, and thus to control the extension of the optical fiber.

Accordingly, the method and the apparatus for coating a thermoplastic resin on a plastic optical fiber that is fed through a die and a nipple are characterized in that the edge of the nipple in the downstream side is located upstream of an die exit formed in the die with respect to the feeding direction of the plastic optical fiber, and that the plastic optical fiber is coated with the thermoplastic resin before reaching the die exit.

In a preferred embodiment, the die has a tapered portion for constituting a resin passage together with the nipple, and a cylindrical land portion connected to the tapered portion and extending toward the die exit. The die satisfies the following conditions;
D≦TA≦1.3×D
TA≦L≦4.0×TA
wherein L (μm) denotes the length of the land portion, TA (μm) denotes the inner diameter of the die exit, and D (μm) denotes the outer diameter of the plastic optical fiber coated with the thermoplastic resin. More preferably, the inner diameter TA is 1.05×D to 1.25×D and the length of the land portion L is TA to 3.5×TA. Most preferably, the inner diameter TA is 1.1×D to 1.2×D and the length of the land portion L is TA to 3.0×TA.

In addition, the die and the nipple satisfy the following condition;
0.7×TA≦TB1≦1.3×TA
10 (μm)≦TB2−D1≦300 (μm)
wherein TB1 (μm) denotes the outer diameter of the edge of the nipple, D1 (μm) denotes the diameter of the plastic optical fiber, and TB2 (μm) denotes the inner diameter of the fiber passage formed in the nipple. More preferably, the outer diameter TB1 is 0.8×TA to 1.2×TA and the value (TB2−D1) is 20 μm to 150 μm. Most preferably, the outer diameter TB1 is 0.9×TA to 1.1×TA and the value (TB2−D1) is 30 μm to 50 μm.

The length of the tapered portion in the feeding direction is preferably between TA and 2×TA, more preferably 1.1×TA and 1.8×TA, and most preferably 1.2×TA and 1.6×TA.

The diameter of the plastic optical fiber is 200 μm to 800 μm. The plastic optical fiber includes a core and a clad formed around the core, the core being formed from acrylic resin.

It is preferable to satisfy the following condition;
Tm≦TD≦(Tm+30)
wherein TD (° C.) is the temperature of the thermoplastic resin in coating on the plastic optical fiber, and Tm (° C.) is the melting point of the thermoplastic resin. The melting point of the thermoplastic resin is preferably 130° C. or higher. The melt flow rate of the thermoplastic resin is preferably 20 g/10 min or smaller. The plastic optical fiber is preferably subject to the step of cooling the plastic optical fiber step by step after coating the thermoplastic resin.

According to the present invention, since the plastic optical fiber being coated with the thermoplastic resin before reaching the exit of the die, it is possible to reduce the tension to the plastic optical fiber and thus to coat the thermoplastic resin without causing deformation of the plastic optical fiber.

Moreover, since the die has the cylindrical land portion that is parallel to the outer surface of the plastic optical fiber, the thickness of the plastic optical fiber becomes uniform. Furthermore, satisfying the above described conditions can prevent deformation, stress distribution of the plastic optical fiber, increase in the transmission loss after coating the thermoplastic resin.

Since the plastic optical fiber is cooled step by step after the thermoplastic resin is coated, it is possible to decrease thermal damage to the plastic optical fiber and to prevent bubbles in the coated layer caused by rapid shrinkage of the thermoplastic resin.

### BRIEF DESCRIPTION OF DRAWINGS

FIG. 1 is a flow chart to manufacture a plastic optical fiber;

FIG. 2 is a schematic view of an apparatus for forming a preform of the plastic optical fiber;

FIG. 3 is a schematic view of another embodiment of the apparatus for forming the preform;

FIG. 4 is a sectional view, in essential part, of the apparatus of FIG. 3;

FIG. 5 is a schematic view of a manufacture equipment of the plastic optical fiber;

FIG. 6 is a schematic view of a coating line for coating the plastic optical fiber;

FIG. 7 is a sectional view, in essential part, of the coating line of FIG. 6;

FIG. 8 is a sectional view of the plastic optical fiber strand after the coating line;

FIG. 9 is a graph to show the refractive index profile in the radial direction of the plastic optical fiber; and

FIG. 10 is a graph to show the refractive index profile of the plastic optical fiber according to another embodiment.

### BEST MODE FOR CARRYING OUT THE INVENTION

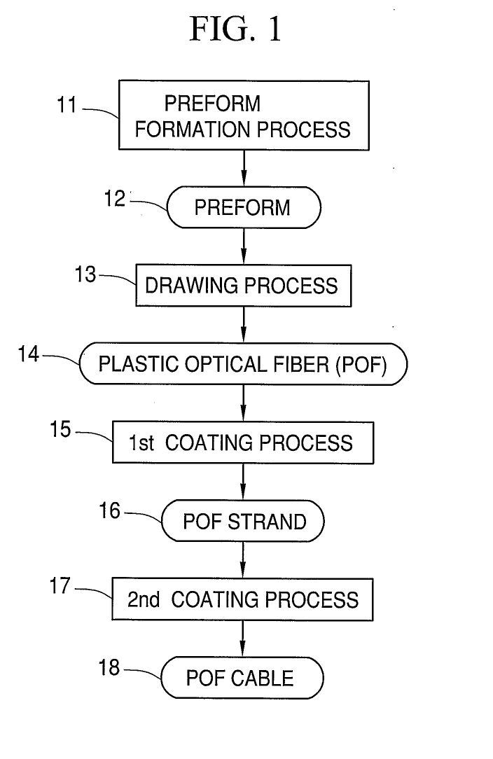

FIG. 1 shows a flow chart to manufacture an optical fiber cable. In a preform formation process 11, a preform 12 is formed from raw polymers for a core part and a outer clad part of the preform. The preform 12 is subject to a drawing process 13 to form a plastic optical fiber (POF) 14 having the desired radius (300 μm to 800 μm, for example). The POF 14 is wound around a winding reel. For the purpose of protecting the POF 14, the preform 12 may be coated in the drawing process 13. It is to be noted that the POF 14 indicates the bare plastic optical fiber or the coated plastic optical fiber. In a first coating process 15, a protective layer is formed on the POF 14 to obtain a plastic optical fiber strand (optical fiber strand) 16.

Although the optical fiber strand 16 may be used as the optical transmission medium, the plastic optical fiber is normally provided with the functions to resist tension, pressure, lateral pressure, bending and moisture. Thus, the optical fiber strands 16 are bunched. The optical fiber strands 16 may be bunched with a shock absorber, if necessary. Then, a second coating process 17 is carried out to form an outermost layer. Thereby, a plastic optical fiber cable (optical fiber cable) 18 is manufactured.

[Raw Material of POF]

(Core Part)

As the raw material of the core part, it is preferable to select a polymerizable monomer that is easily bulk polymerized. Examples of the raw materials with high optical transmittance and easy bulk polymerization are (meth)acrylic acid esters [(a) (meth)acrylic ester without fluorine, (b) (meta)acrylic ester containing fluorine], (c) styrene type compounds, (d) vinyl esters, or the like. The core part may be formed from a homopolymer composed of one of these monomers, a copolymer composed of at least two kinds of these monomers, or a mixture of the homopolymer(s) and/or the copolymer(s). Among them, (meth)acrylic acid ester is preferably used as the polymerizable monomer.

Concretely, examples of the (a) (meth)acrylic ester without fluorine as the polymerizable monomer are methyl methacrylate (MMA); ethyl methacrylate; isopropyl methacrylate; tert-butyl methacrylate; benzyl methacrylate (BzMA); phenyl methacrylate; cyclohexyl methacrylate, diphenylmethyl methacrylate; tricyclo[5·2·1·0^{2.6}]decanyl methacrylate; adamanthyl methacrylate; isobonyl methacrylate; methyl acrylate; ethyl acrylate; tert-butyl acrylate; phenyl acrylate, and the like. Examples of (b) (meth)acrylic ester with fluorine are 2,2,2-trifluoroethyl methacrylate; 2,2,3,3-tetrafluoro propyl methacrylate; 2,2,3,3,3-pentafluoro propyl methacrylate; 1-trifluoromethyl-2,2,2-trifluoromethyl methacrylate; 2,2,3,3,4,4,5,5-octafluoropenthyl methacrylate; 2,2,3,3,4,4,-hexafluorobutyl methacrylate, and the like. Further, in (c) styrene type compounds, there are styrene; α-methylstyrene; chlorostyrene; bromostyrene and the like. In (d) vinylesters, there are vinylacetate; vinylbenzoate; vinylphenylacetate; vinylchloroacetate; and the like. The polymerzable monomers are not limited to the monomers listed above. Preferably, the kinds and composition of the monomers are selected such that the refractive index of the homopolymer or the copolymer in the core part is similar or higher than the refractive index in the outer clad part. As the polymer for the raw material, polymethyl methacrylate (PMMA), which is a transparent resin, is more preferable.

When the POF is used for transmission of near infrared ray, the C—H bond in the optical member causes absorption loss. By use of the polymer in which the hydrogen atom (H) of the C—H bond is substituted by the heavy hydrogen (D) or fluorine (F), the wavelength range to cause transmission loss shifts to larger wavelength region. Japan Patent No. 3332922 (counterpart of U.S. Patent No. 5,541,247) teaches the examples of such polymers, such as deuteriated polymethylmethacrylate (PMMA-d8), polytrifluoroethylmethacrylate (P3FMA), polyhexafluoro isopropyl-2-fluoroacrylate (HFIP 2-FA). Thereby, it is possible to reduce the loss of transmission light. It is to be noted that the impurities and foreign materials in the monomer that causes dispersion should be sufficiently removed before polymerization so as to keep the transparency of the POF after polymerization.

(Clad Part)

In order that the transmitted light in the core part is completely reflected at the interface between the core part and the clad part, the material for the clad part is required to have smaller refractive index than the core part and exhibits excellent fitness to the core part. If there is irregularity between the core part and the clad part, or if the material for the clad part does not fit the core part, another layer may be provided between the core part and the clad part. For example, an inner clad layer, formed on the surface of the core part (inner wall of the tubular clad pipe) from the same composition as the matrix of the core part, can improve the condition of the interface between the core part and the clad part. The description of the inner clad layer will be explained later. Instead of the inner clad layer, the clad part may be formed from the polymer having the same composition as the matrix of the core part. The inner clad layer is preferable in order to improve optical and/or mechanical properties of the plastic optical fiber, but the plastic optical fiber may not include the inner clad layer.

A material having excellent toughness, moisture resistance and heat-resistance is preferable for the clad part. For example, a polymer or a copolymer of the monomer including fluorine is preferable. As the monomer including fluorine, vinylidene fluoride (PVDF) is preferable. It is also preferable to use a fluorine resin obtained by polymerizing one kind or more of polymerizable monomer having 10 wt % of vinylidene fluoride.

In the event of forming the polymer for the clad part by melt-extrusion, the viscosity of the molten polymer needs to be appropriate. The viscosity of the molten polymer is related to the molecular amount, especially the weight-average molecular weight. In this preferable embodiment, the weight-average molecular weight is preferably 10,000 to 1,000,000, and more preferably 50,000 to 500,000.

It is also preferable to protect the core part from moisture. Thus, a polymer with low hygroscopic rate is used as the material for the clad part. The clad part may be formed from the polymer having the saturated hygroscopic rate (hygroscopic rate) of less than 1.8%. More preferably, the hygroscopic rate of the polymer is less than 1.5%, and most preferably less than 1.0%. The inner clad layer is preferably formed from the polymer having similar hygroscopic rate. The hygroscopic rate (%) is obtained by measuring the hygroscopic rate after soaking the sample of the polymer in the water of 23° C. for one week, pursuant to the ASTM D 570 experiment.

(Polymerization Initiator)

In polymerizing the monomer to form the polymer as the core part and the clad part, polymerization initiators can be added to initiate polymerization of the monomer. The polymerization initiator to be added is appropriately chosen in accordance with the monomer and the method of polymerization. Examples of the polymerization initiators that generate radicals are peroxide compounds, such as benzoil peroxide (BPO); tert-butylperoxy-2-ethylhexanate (PBO); di-tert-butylperoxide (PBD); tert-butylperoxyisopropylcarbonate (PBI); n-butyl-4,4-bis(tert-butylperoxy)valarate (PHV), and the like. Other examples of the polymerization initiators are azo compounds, such as 2,2′-azobisisobutylonitril; 2,2′-azobis(2-methylbutylonitril); 1,1′-azobis(cyclohexane-1-carbonitryl); 2,2′-azobis(2-methylpropane); 2,2′-azobis(2-methylbutane)2,2′-azobis(2-methylpentane); 2,2′-azobis(2,3-dimethylbutane); 2,2′-azobis(2-methylhexane); 2,2′-azobis(2,4-dimethylpentane); 2,2′-azobis(2,3,3-trimethylbutane); 2,2′-azobis(2,4,4-trimethylpentane); 3,3′-azobis(3-methylpentane); 3,3′-azobis(3-methylhexane); 3,3′-azobis(3,4-dimethypentane); 3,3′-azobis(3-ethylpentane); dimethyl-2,2′-azobis(2-methylpropionate); diethyl-2,2′-azobis(2-methylpropionate); di-tert-butyl-2,2′-azobis(2-methylpropionate), and the like. Note that the polymerization initiators are not limited to the above substances. More than one kind of the polymerization initiators may be combined.

(Chain Transfer Agent)

The polymerizable compositions for the clad part and the core part preferably contain a chain transfer agent for mainly controlling the molecular weight of the polymer. The chain transfer agent can control the speed and the degree of polymerization in forming the polymer from the polymerizable monomer, and thus it is possible to control the molecular weight of the polymer. For instance, in drawing the preform to manufacture the POF, adjusting the molecular weight by the chain transfer agent can control the mechanical properties of the POF in the drawing process. Thus, adding the chain transfer agent makes it possible to increase the productivity of the POF.

The kind and the amount of the chain transfer agent are selected in accordance with the kinds of the polymerizable monomer. The chain transfer coefficient of the chain transfer agent to the respective monomer is described, for example, in “Polymer Handbook, 3^{rd} edition”, (edited by J. BRANDRUP & E. H. IMMERGUT, issued from JOHN WILEY&SON). In addition, the chain transfer coefficient may be calculated through the experiments in the method described in “Experiment of Polymer Composition” (edited by Takayuki Ohtsu and Masayoshi Kinoshita, issued from Kagakudojin, 1972).

Preferable examples of the chain transfer agent are alkylmercaptans [for instance, n-butylmercaptan; n-pentylmercaptan; n-octylmercaptan; n-laurylmercaptan; tert-dodecylmercaptan, and the like], and thiophenols [for example, thiophenol; m-bromothiophenol; p-bromothiophenol; m-toluenethiol; p-toluenethiol, and the like]. It is especially preferable to use n-octylmercaptan, n-laurylmercaptan, and tert-dodecylmercaptan in the alkylmercaptans. Further, the hydrogen atom in C—H bond may be substituted by the fluorine atom (F) or a deuterium atom (D) in the chain transfer agent. Note that the chain transfer agents are not limited to the above substances. More than one kind of the chain transfer agents may be combined.

(Refractive Index Control Agent)

The refractive index control agent may be preferably added to the polymerizable composition for the core part. It is also possible to add the refractive index control agent to the polymerizable composition for the clad part. The core part having refractive index profile can be easily generated by providing the concentration distribution of the refractive index control agent. Without the refractive index control agent, it is possible to form the core part having refractive index profile by providing the profile in the co-polymerization ratio of more than one kind of the polymerizable monomers in the core part. But in consideration of controlling the composition of the copolymer, adding the refractive index control agent is preferable.

The refractive index control agent is referred to as “dopant”. The dopant is a compound that has different refractive index from the polymerizable monomer to be combined. The difference in the refractive indices between the dopant and the polymerizable monomer is preferably 0.005 or larger. The dopant has the feature to increase the refractive index of the polymer, compared to one that does not include the dopant. In comparison of the polymers produced from the monomers as described in Japanese Patent Publication No. 3332922 and Japanese Patent Laid-Open Publication No. 5-173026, the dopant has the feature that the difference in solution parameter is 7 (cal/cm³)^{1/2} or smaller, and the difference in the refractive index is 0.001 or larger. Any materials having such features may be used as the dopant if such material can stably exist with the polymers, and the material is stable under the polymerizing condition (such as temperature and pressure conditions) of the polymerizable monomers as described above.

Any materials having such features may be used as the dopant if such material can change the refractive index and stably exists with the polymers, and the material is stable under the polymerizing condition (such as temperature and pressure conditions) of the polymerizable monomers as described above. This embodiment shows the method to form refractive index profile in the core part by mixing the dopant with the polymerizable compound for the core part, by controlling the direction of polymerization according to the interface gel polymerizing method, and by providing gradation in density of the refractive index control agent as the dopant during the process to form the core part. Hereinafter, the core having the refractive index profile will be referred to as “graded index core”. Such graded index core is used for the graded index type plastic optical member having wide range of transmission band. The dopant may be polymerizable compound, and in that case, it is preferable that the copolymer having the dopant as the copolymerized component increases the refractive index in comparison of the polymer without the dopant. An example of such copolymer is MMA-BzMA copolymer.

Examples of the dopants are benzyl benzoate (BEN); diphenyl sulfide (DPS); triphenyl phosphate (TPP); benzyl n-butyl phthalate (BBP); diphenyl phthalate (DPP); diphenyl (DP); diphenylmethane (DPM); tricresyl phosphate (TCP); diphenylsoufoxide (DPSO), diphenyl sulfide derivatives, and dithiane derivatives. Among them, BEN, DPS, TPP, DPSO, diphenyl sulfide derivatives, and dithiane derivatives are preferable.

For the purpose of improving transparency in a wide wavelength range, it is possible to utilize the compound in which the hydrogen atom is substituted by the fluorine atom or the deuterium atom. In the event that the dopant is polymerizable compounds such as tribromo phenylmethacrylate, there may be advantageous in heat resistance although it would be difficult to control various properties (especially optical property) because of copolymerization of the polymerizable monomer and the polymerizable dopant.

It is possible to control the refractive index of the POF by controlling the density and distribution of the refractive index control agent to be mixed with the core part. The amount of the refractive index control agent may be appropriately chosen in accordance with the purpose of the POF, the core material, and the like.

More than one kind of the dopant may be added to the polymerizable compound. In that case, the dopant preferably has benzene ring, and the Hammett value of the substituent (weighed average of the Hammett constants thereof if the dopant has plural substituents) is preferably 0.04 or smaller and the SP value thereof is preferably 10.9 or smaller.

(Other Additives)

Other additives may be contained in the core part and the clad part so as not to decrease the optical transmittance. For example, the stabilizer may be used for increasing the resistance to climate and durability. Further, induced emissive functional compounds may be added for amplifying the optical signal. When such compounds are added to the monomer, attenuated signal light is amplified by excitation light so that the transmission distance increases. Therefore, the optical member with such additive may be used as an optical fiber amplifier in the optical transmission link. These additives may be contained in the core part and/or the clad part by polymerizing the additives with the monomer.

(Method for Manufacturing Preform)

The method for manufacturing a graded index type plastic optical fiber base body having the core part and the clad part will be described as a preferable embodiment of the present invention. The following two embodiments of manufacture methods do not limit the present invention.

In the first embodiment, the polymerizable compositions for the clad part are polymerized to form a hollow pipe. Instead, the hollow cylindrical pipe is formed by melt extrusion of a thermoplastic resin (1st process). The core part is formed by interfacial gel polymerization of the polymerizable composition for the core part in the hollow cylindrical pipe, so the preform having the core part and the clad part is produced (2nd process). The preform is subject to change its shape (3rd process) to manufacture the POF. In the 2nd process, the graded index type POF is manufactured by interfacial gel polymerization of the polymerizable compound mixed with the dopant.

In the second embodiment, the inner clad part is formed inside the hollow pipe (outer clad part) corresponding to the clad part of the first embodiment (1'st process).

For instance, the hollow cylindrical pipe is formed from a resin including fluorine, such as polyvinylidene fluoride. The cylindrical pipe including two layers is produced by forming the inner clad layer inside the single layer cylindrical pipe by rotational polymerization of the polymerizable composition for the inner clad (1'st process). Then, the core part is formed in the hollow area of the double layer cylindrical pipe by the interfacial gel polymerization of the polymerizable composition for the core part (2'nd process), so the preform is formed. After changing the shape of the preform appropriately (3rd process), the POF as the optical member is manufactured.

Although the double layered cylindrical pipe according to the second embodiment is formed step by step as described above, it is possible to form the double layered cylindrical pipe by a single step of melt extrusion of the resin including fluorine for the outer clad part and the polymerizable composition for the inner clad part.

The composition of the polymerizable monomers for the clad part is preferably the same as that for the core part according to the first embodiment. In the second embodiment, the composition of the polymerizable monomers for the inner clad part is preferably the same as that for the core part. The composition ratio of the polymerizable monomers is not necessarily the same, and an accessory ingredient to be added to the polymerizable monomers is not necessarily the same. Providing the same kinds of the polymerizable monomers can improve the optical transmittance and the adhesiveness at the interface between the clad part and the core part (or at the interface between the inner clad part and the core part, according to the second embodiment). When the resin of the outer clad part or the inner clad part is copolymer in which the components thereof have different refractive indices, adjusting the mixed ratio of the components can provide a large difference in the refractive index between the core part and the outer clad part or the core part. As a result, the graded index structure is easily provided.

In the second embodiment, the inner clad layer between the outer clad part and the core part can prevent to decrease the adhesiveness and the productivity of the POF caused by the difference of the materials for the outer clad part and the core part. Thus, it is possible to increase the materials that can be used for the outer clad part and the core part. The thickness and the diameter of the cylindrical pipe corresponding to the outer clad part can be controlled in the melt extrusion process of commercial fluorine resin or in the rotational polymerization process of the polymerizable composition. In the hollow area of the cylindrical pipe, the polymerizable composition for the inner clad part is subject to rotational polymerization, so the inner clad part is formed inside the cylindrical pipe. The same structure may be formed by co-extrusion of the copolymer composed of the fluorine resin and the polymerizable composition.

In these preferable embodiments, the graded index type POF is manufactured by providing the concentration profile of the refractive index control agent. The present invention is also applicable to other type of POF. In addition, the concentration profile of the refractive index control agent may be provided by interfacial gel polymerization and rotational gel polymerization, which will be described later.

The preferable amount of the ingredients of the polymerizable composition for the outer clad part, the inner clad part and the core part can be determined in accordance of the kind of the ingredients. In general, the amount of the polymerization initiator is preferably 0.005 wt % to 0.5 wt % of the polymerizable monomer, and more preferably 0.01 wt % to 0.5 wt %. The amount of the chain transfer agent is preferably 0.10 wt % to 0.40 wt % of the polymerizable monomer, and more preferably 0.15 wt % to 0.30 wt %. The amount of the refractive index control agent is preferably 1 wt % to 30 wt % of the polymerizable monomer, and more preferably 1 wt % to 25 wt %.

In consideration of the drawing process of the obtained preform, the weight-average molecular weight of the polymer obtained by polymerizing the polymerizable composition for the outer clad part, the inner clad part and the core part is preferably 10,000 to 1,000,000. More preferably, the weight-average molecular weight is 30,000 to 500,000. The drawing property of the preform is affected by the molecular weight distribution (MWD), calculated by dividing weight-average molecular weight by number average molecular weight. The preform having a large MWD is not preferable because the portion having extremely high molecular weight exhibits bad drawing property, and what is worse, the preform cannot be drawn. Thus, the value of MWD is preferably 4 or smaller, and more preferably 3 or smaller.

Next, each manufacture process according to the first embodiment and the second embodiment (especially the first embodiment) will be described in detail.

(First Process)

In the first process, the single layered cylindrical pipe for the clad part, or the double layered cylindrical pipe for the outer clad part and the inner clad part is formed. Such cylindrical pipe is formed by polymerizing the monomers and shaping it in a tubular form. For example, the cylindrical pipe is formed by the rotational polymerization described in Japan Patent No. 3332922 and the melt-extrusion of the resin.

The hollow cylindrical pipe is formed from the polymerizable composition by the rotational polymerization method in which the polymerizable composition is polymerized while a cylindrical polymerization chamber (outer clad pipe) containing the composition is rotated. After the polymerizable composition for the clad part (inner clad part) are poured in the polymerization chamber (outer clad part of fluorine resin), the polymerization chamber (outer clad part) is rotated (preferably, the axis of the polymerization chamber is kept horizontally) and the polymerizable composition is polymerized. Thereby, the clad part is formed inside the cylindrical polymerization chamber. According to the second embodiment, the inner clad part is formed inside the outer clad part.

Before putting the polymerizable composition in the clad part or the hollow inner clad part, the polymerizable composition is preferably filtered to remove dust contained in the polymerizable composition. Moreover, it is possible to adjust the viscosity of the raw materials (polymerizable composition) for easy handling, as disclosed in JP-A 10-293215, and to carry out preliminary polymerization for shorting the polymerization period, as long as these processes do not cause deterioration in the quality of the preform and the processes before and after the polymerization do not become complicated. The temperature and the period for the polymerization process are determined in accordance with the monomers and the polymerization initiators to be used for polymerization. Generally, the preferable polymerization period is 5 hours to 24 hours. The preferable polymerization temperature is 60° C. to 150° C. As described in JP-A No. 08-110419, the raw materials may be subject to the preliminary polymerization for increasing its viscosity. Such preliminary polymerization can shorten the polymerization period for forming the cylindrical pipe. The polymerization chamber is preferably a metal or glass chamber with high rigidity, because the cylindrical polymer pipe is distorted if the polymerization chamber is deformed during rotation.

The cylindrical pipe may be formed from pelletized or powdered resin (preferably fluorine resin). After sealing both ends of the cylindrical polymerization chamber containing the pelletized or powdered resin, the polymerization chamber is rotated (preferably, the axis of the polymerization chamber is kept horizontally). Then, by heating the resin at a temperature more than the melting point of the resin, the hollow cylindrical polymer pipe is formed. In order to prevent heat, oxidization and decompression by thermal oxidization of the molten resin, the polymerization chamber is preferably filled with inert gas such as nitrogen gas, carbon dioxide gas and argon gas. Moreover, it is preferable to dry the resin sufficiently before the polymerization process.

In the event of forming the clad part by extruding the molten polymer, the shape of the polymer (cylindrical shape) after polymerization is appropriately controlled by use of molding technique like extrusion. The apparatus for the melt extrusion of the polymer has two types, the inner sizing die type and the outer die decompression absorption type.

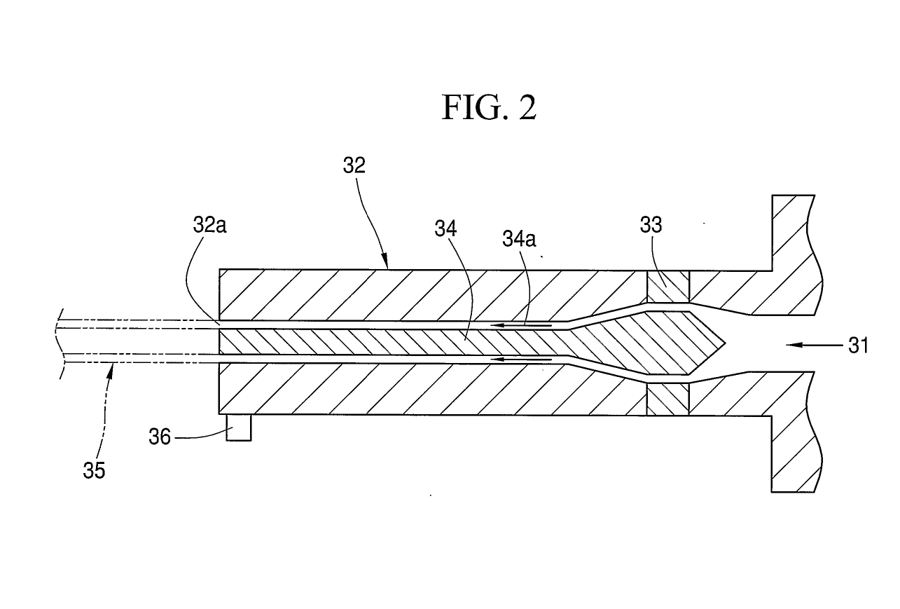

Referring to FIG. 2, the melt extrusion apparatus of the inner sizing die type is described. In the melt extrusion apparatus, a single screw extruder (not illustrated) extrudes a raw polymer 31 for the clad part to a die body 32. In the die body 32, a guide member 33 for changing the shape of the raw polymer 31 into the cylindrical shape is provided. Through the guide member 33, the raw polymer 31 passes a flowing passage 34a between the die body 32 and an inner rod 34. The raw polymer 31 is extruded from an outlet 32a of the die body 32 so that a clad part 35 having the hollow cylindrical pipe is formed. Although there is no limitation to the extrusion speed of the clad part 35, in terms of productivity and the uniformity of the clad part 35, the extrusion speed is preferably 1 cm/min to 100 cm/min.

The die body 32 preferably comprises a heater (not illustrated) for heating the raw polymer 31. For instance, one or more heater (for instance, heat generating device by use of steam, thermal oil and an electric heater) are provided along the flowing passage 34a so as to coat the die body 32. A thermometer 36 is provided in the vicinity of the outlet 32a of the die body 32. In order to control the heating temperature, the thermometer 36 measures the temperature of the clad part 35 near the outlet 32a.

A cooling section may be provided in the die body 32. The temperature of the clad 35 may be controlled by a thermostat (for example, a cooler device that utilizes liquid like water, an anti-freezing solution and oil, and an electric cooling device) that is fixed to the die body 32. The clad 35 may be cooled by natural cooling of the die body 32. When the heater device is provided with the die body 32, the cooler device is preferably provided in the downstream side of the heater device with respect to the direction to flow the raw polymer 31.

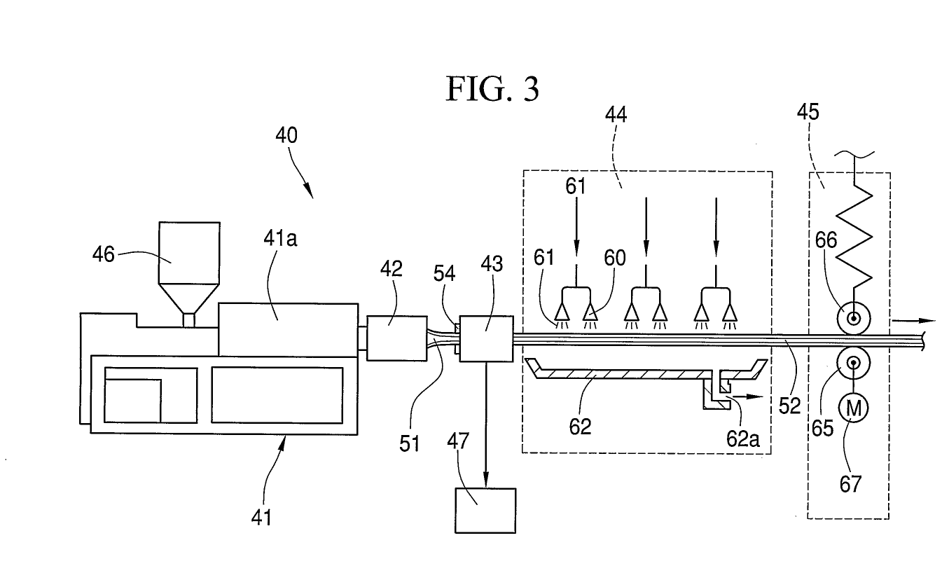

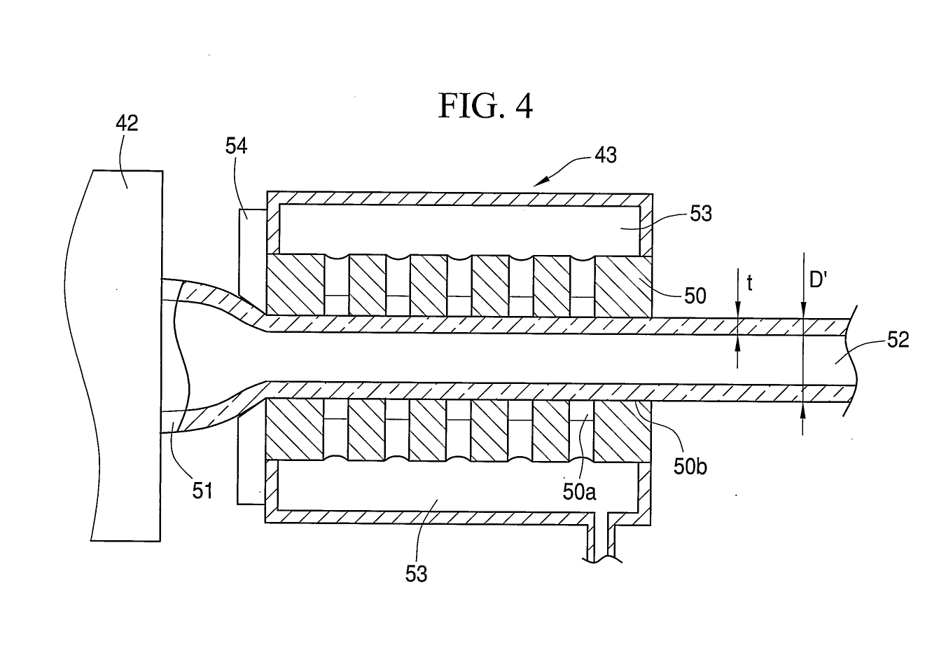

Referring to FIGS. 3 and 4, the melt extrusion apparatus of the outer die decompression absorption type is described. FIG. 3 shows an embodiment of a manufacture line 40 including the melt extrusion apparatus. In FIG. 4, a cross section of a molding die 43 in the manufacture line 40 is illustrated.

Referring to FIG. 3, the manufacture line 40 comprises a melt extrusion apparatus 41, an extrusion die 43, a cooler device 44 and a feeding machine 45. The raw polymer supplied from a pellet casting hopper 46 is melted in a melting section 41a provided in the melt extrusion apparatus 41. The molten polymer is extruded by the extrusion die 42, and then supplied to the molding die 43. The molding die 43 is connected with a vacuum pump 47. The extrusion speed S is preferably 0.1 (m/min) to 10 (m/min), more preferably 0.3 (m/min) to 5.0 (m/min), and most preferably 0.4 (m/min) to 1.0 (m/min). The extrusion speed S is not limited to the preferable ranges mentioned above.

As shown in FIG. 4, the molding die 43 has a molding pipe 50 through which the raw polymer is shaped to form the hollow cylindrical clad 52. There are plural suction holes 50a in the molding pipe 50. The suction holes 50a are connected to a decompression chamber 53, provided outside of the molding pipe 50. When the decompression chamber 53 is decompressed by the vacuum pump 47, the outer wall of the clad 52 comes in close contact with the molding surface (inner surface) of the molding pipe 50, so the thickness of the clad 52 becomes uniform. The pressure in the decompression chamber 53 (absolute pressure) is preferably 20 kPa to 50 kPa, but not limited to this range. In order to regulate the diameter of the clad 52, a throat member (diameter regulation member) 54 is preferably fixed at the entrance of the molding die 43.

The clad 52 through the molding die 43 for shaping is fed to the cooler device 44, in which plural nozzles 60 are provided for spraying cooling water 61 to the clad 52. Thereby, the clad 52 is cooled and becomes solidified. The sprayed cooling water 61 is collected in a water receiver 62, and then ejected through a drain opening 62a. The clad 52 is drawn from the cooler device 44 toward the winding machine 45. The winding machine 45 comprises a drive roller 65 and a pressure roller 66. The winding speed by the feeding machine 45 is controlled by a motor 67 that is connected to the drive roller 65. The clad 52 is sandwiched between the drive roller 65 and the pressure roller 66. The feeding speed of the clad 52 is adjusted by the drive roller 65 and the feeding position of the clad 52 is adjusted by the pressure roller 66. Thereby, it is possible to keep the shape and the thickness of the clad 52. If necessary, the drive roller 65 and the pressure roller 66 may be belt-shaped.

The clad may be composed of plural layers for the purpose of providing functions such as the mechanical strength and incombustibility. In addition, after the hollow cylindrical pipe having the arithmetic average roughness of a certain range is formed, the outer surface of the cylindrical pipe may be coated with fluorine resin or the like.

In terms of optical properties and productivity of the clad 52, the outer diameter D′ of the clad 52 is preferably 50 mm or smaller, and more preferably the outer diameter D′ is 2 mm to 30 mm. The thickness t of the clad 52 can be small as long as the clad 52 can keep its shape. The thickness t is preferably 2 mm to 20 mm. These numerical ranges of the outer diameter D′ and the thickness t do not limit the present invention.

Examples of the polymerizable monomers as the raw material of the inner clad layer are the same as those of the core part. The inner clad layer is mainly provided for forming the core part, so the thickness of the inner clad layer may be small as long as the core part can be bulk polymerized. The inner clad layer may be merged with the core part to form a single core part after the bulk polymerization of the core part. Thus, the lower limit of the thickness t2 of the inner clad layer before the bulk polymerization is preferably 0.5 mm to 1.0 mm or larger. The upper limit of the thickness t2 may be selected in accordance with the size of the preform, as long as the core part has refractive index profile.

The single or double layered cylindrical structure formed from a polymer preferably has a bottom part to close one end of the cylindrical structure for putting the polymerizable composition as the raw material of the core part. It is preferable that the bottom part is formed from a material having excellent adhesion and fitness to the polymer of the cylindrical pipe. The bottom part may be formed from the same polymer as the cylindrical structure. The polymer bottom part is formed, for example, by polymerizing a small amount of the polymerizable monomer injected in the polymerization chamber that is kept vertically before rotating the polymerization chamber for polymerization or after forming the hollow cylindrical pipe.

For the purpose of promoting reaction of the remaining monomers and the polymerization initiators after the rotational polymerization, the hollow polymer pipe may be heated at a temperature higher than the temperature in the rotational polymerization process. After the hollow polymer pipe is formed, non-polymerized compounds may be ejected.

(Second Process)

In the second process, the polymerizable monomers in the polymerizable composition filled in the hollow pipe are polymerized to form the core part. According to the interfacial gel polymerization, the polymerizable monomers are polymerized from the inner wall of the hollow pipe toward the center thereof. When more than one kind of the polymerizable monomer is used, the monomers with higher affinity with the polymer of the hollow pipe are initially polymerized so that such monomers are localized near the inner wall of the hollow pipe. The proportion of the monomers with higher affinity decreases from the surface of the hollow pipe to the center thereof, while the proportion of other monomers increases. In this way, the proportion of the monomers gradually changes in the area corresponding to the core part, so the refractive index profile is introduced.

When the monomers with the refractive index control agent are polymerized, the core liquid solidifies the inner wall of the hollow pipe, and the polymers in the inner wall is swelled to form a gel, as described in Japanese Patent No. 3332922. During the polymerization, the monomers with higher affinity to the hollow pipe are localized in the area near the inner wall of the hollow pipe. Thus, the density of the refractive index control agent of the polymer becomes smaller in the area near the inner wall of the hollow pipe, and the density of the refractive index control agent increases as the distance from the inner wall of the hollow pipe. In this way, the concentration profile of the refractive index control agent is generated, and thus the refractive index profile is provided in the core part.

The speed and the degree of polymerization of the polymerizable monomers are adjusted by the polymerization initiator and the chain transfer agent to be added if necessary, and thereby the molecular weight of the polymer is adjusted. For instance, in the event of forming the POF by drawing the polymer, adjusting the molecular weight (preferably 10,000 to 1,000,000, and more preferably 30,000 to 500,000) by use of the chain transfer agent can control the mechanical property in the drawing process within a desirable range. Accordingly, the productivity of the POF improves.

In the second process, the refractive index profile is introduced in the area corresponding to the core part, but the thermal behavior of the polymer changes according to the refractive index. Thus, when the monomers in the core part are polymerized at the same temperature, the response of the volume shrinkage in polymerization becomes different over the area corresponding to the core part due to the difference in thermal behavior. Thus, bubbles are mixed in the preform. It is also possible that microscopic gap is generated in the preform, and that the bubbles are generated in heating and drawing the preform. Too low polymerization temperature causes to decrease polymerization efficiency. Moreover, when the polymerization temperature is too low, the productivity of the preform becomes worse, and the optical transmittance of the manufactured optical part becomes worse due to low optical transparency caused by improper polymerization. On the other hand, if the initial polymerization temperature is too high, the initial polymerization speed is excessively increased. As a result, since the polymer cannot be relaxed to the volume shrinkage in the area of the core part, the bubbles are easily generated in the preform.

In order to prevent the above problems, it is preferable to keep the initial polymerization temperature T1 (° C.) within the following range:
(Tb−10)(° C.)≦T1(° C.)≦Tg(° C.)

It is to be noted that Tb is the boiling point of the polymerizable monomer, and Tg is the glass transition point (glass transition temperature) of the polymer of the polymerizable monomer.

After the initial polymerization at the temperature T1, the monomers are polymerized at the temperature T2 (° C.) that satisfies the following condition:
Tg(° C.)≦T2(° C.)≦(Tg+40)(° C.)
T1(° C.)<T2(° C.)

By completing the polymerization after increasing the temperature from T1 to T2, it is possible to prevent deterioration in the optical transparency, and thus to obtain the preform with excellent optical transmittance. In addition, the effect of thermal deterioration and depolymerization of the preform becomes smaller, and it is possible to decrease deviation in the polymer density in the preform, and to improve the transparency of the preform. The polymerization temperature T2 (° C.) is preferably Tg (° C.) to (Tg+30) ° C., and more preferably about (Tg+10) ° C. The polymerization temperature T2 of less than Tg (° C.) cannot obtain such effect. When the polymerization temperature T2 is higher than (Tg+40) ° C., the transparency of the preform will decrease because of thermal deterioration and depolymerization. Moreover, in forming the graded index type core part, the refractive index profile in the core part is destroyed, so the properties of the POF are largely decreased.

The polymerizable monomers are preferably polymerized at the polymerization temperature T2 until the polymerization is completed so that the polymerization initiator does not remain. If non-reacted polymerization initiators remaining in the preform are heated in processing the preform, especially in melt drawing process, polymerization initiators are decompressed to generate the bubbles in the preform. So it is preferable that the polymerization initiators are completely reacted. The period of polymerization at the polymerization temperature T2 is preferably equal to or longer than the half-life of the polymerization initiators at the temperature T2, although the preferable polymerization period depends on the kind of the polymerization initiator.

The polymerization initiator is preferably a compound having the ten-hour half-life temperature of (Tb−20) ° C. or higher, wherein Tb is the boiling point of the polymerizable monomer. Polymerizing the monomers at the initial polymerization temperature T1 (° C.) with the polymerization initiator having the ten-hour half-life temperature of equal to or higher than (Tb−20) ° C. can decrease the polymerization speed at the initial stage. In addition, it is preferable to polymerize the monomers at the initial polymerization temperature T1 (° C.) satisfying the above condition for a period equal to or more than 10% of the half-life of the polymerization initiator. Thereby, the polymer can quickly relax to the volume shrinkage by a pressure during the initial polymerization. Setting the above described conditions can decrease the initial polymerization speed, and improves the response to the volume shrinkage in the initial polymerization. As a result, since the amount of the bubbles to be introduced to the preform by the volume shrinkage decreases, it is possible to improve the productivity. It is to be noted that the ten-hour half-life temperature of the polymerization initiator is the temperature in which the amount of the polymerization initiator becomes half in ten hours by decomposition.

In polymerizing the monomers with the polymerization initiator satisfying the above conditions at the initial polymerization temperature T1 (° C.) for a period of equal to or more than 10% of the half-life of the polymerization initiator, it is possible to keep the initial polymerization temperature T1 (° C.) until the polymerization is completed. In order to obtain the optical member having high optical transparency, completing polymerization at the polymerization temperature T2 (° C.) that is higher than the initial polymerization temperature T1 (° C.) is preferable. The preferable temperature of the polymerization temperature T2 (° C.) and the period for polymerization at the temperature T2 (° C.) are mentioned above.

When methyl methacrylate (MMA) with the boiling point Tb of 100° C. is used as the polymerizable monomer in the second process, PBD and PHV can be used as the polymerization initiator with the ten-hour half-life temperature of (Tb−20) ° C. or higher. For example, when MMA is used as the polymerizable monomer and PBD is used as the polymerization initiator, it is preferable to keep the initial polymerization temperature T1 (° C.) at 100-110° C. for 48-72 hours, to increase the temperature to the polymerization temperature T2 (° C.) of 120-140° C., and to carry out polymerization at T2 (° C.) for 24-48 hours. In the event of PHV as the polymerization initiator, it is preferable to keep the initial polymerization temperature T1 (° C.) at 100-110° C. for 4-24 hours, to increase the temperature to the polymerization temperature T2 (° C.) of 120-140° C., and to carry out polymerization at T2 (° C.) for 24-48 hours. The temperature in polymerization may be increased step by step or continuously. It is preferable to increase the temperature in polymerization as quickly as possible.

In the second process, the pressure in polymerization may be increased or decreased, as described in JP-A No. 09-269424 and Japanese Patent No. 3332922. Moreover, the pressure can be changed during polymerization. Changing the pressure during polymerization can improve polymerization efficiency at the initial polymerization temperature T1 (° C.), near the boiling point Tb (° C.) and satisfying the above condition, and the polymerization temperature T2 (° C.). In polymerizing the monomer under a pressurized condition (pressurized polymerization), the hollow pipe containing the polymerizable monomer is preferably supported in a hollow portion of a jig. Moreover, dehydration and degassing in a low pressure condition before polymerization can effectively decrease the bubbles to be generated.

The jig to support the hollow pipe is provided with a hollow part for inserting the above described hollow pipe, and the hollow part of the jig preferably has the same shape as the hollow pipe. In other words, the jig has preferably a hollow cylindrical shape. The jig can prevent deformation of the hollow pipe during the pressurized polymerization, and can support the hollow pipe enough to relax the shrinkage of the core part as the pressurized polymerization proceeds. Accordingly, the diameter of the hollow part of the jig is preferably larger than the diameter of the hollow pipe, so the hollow pipe in the jig does not come in contact with the inner wall of the hollow pipe. Compared to the outer diameter of the hollow pipe, the diameter of the hollow part of the jig is preferably larger by 0.1% to 40% of the outer diameter of the hollow pipe, and more preferably larger by 10% to 20% of the outer diameter of the hollow pipe.

The jig containing the hollow pipe is set in the polymerization chamber. The longitudinal direction of the hollow pipe in the polymerization chamber is preferably held vertically. After setting the hollow pipe supported by the jig in the polymerization chamber, the polymerization chamber is subject to pressurization. In proceeding pressurized polymerization, the polymerization chamber is preferably pressurized in the atmosphere of inert gas like nitrogen gas. The pressure (gauge pressure) in polymerization is preferably 0.05 MPa to 1.0 MPa in general, although the preferable pressure depends on the type of the monomer to be polymerized.

The method to manufacture the core part is not limited to the above described process. For instance, the core part may be formed by rotational polymerization method to carry out interfacial gel polymerization during the rotation of the monomers for the core part. In the following explanation, the core is formed. In the outer clad pipe having the inner clad, the core solution is injected. Then, after sealing one end of the outer clad pipe, the outer clad pipe is kept in the polymerization chamber horizontally (in the state in which the longitudinal direction of the outer clad pipe is kept horizontally), and the core solution is subject to polymerization while the outer clad pipe is rotated. The core may be injected collectively, continuously or successively in the outer clad pipe. Instead of the GI type POF, a multi step type optical fiber having step-shape refractive index profile by adjusting the amount, composition and polymerization degree of the core polymerizable composition. In the preferred embodiment, the above described method of polymerization is referred to as a core part rotational polymerization method (core part rotational gel polymerization method).

Compared with the interfacial gel polymerization, the rotational polymerization method can discharge the bubbles to be generated from the core solution because the core solution has a larger surface area than the gel. Therefore, the amount of the bubbles in the obtained preform decreases. In addition, forming the core part by the rotational polymerization method, the preform may have a void in the center. In such case, the void in the preform is filled by the melt drawing process to manufacture a plastic optical member such as the POF. Such preform can be utilized as other type of the optical member like the plastic lens by closing the void in the preform in the melt drawing process.

The amount of the bubbles to be generated after the polymerization process can be decreased by cooling the preform at a constant cooling speed under the control of the pressure at the stage to complete the second process. In terms of the pressure response of the core part, the pressure polymerization of the core part in the atmosphere of inactive gas (such as nitrogen gas) is preferable. But it is impossible to completely discharge the gas from the preform, and the cooling process will cause rapid shrinkage of the polymer so that the bubble are generated due to the bubble nucleus formed by gas accumulation to the void in the preform. In order to prevent such problem, it is preferable to control the cooling speed. The cooling speed is preferably 0.001° C./min to 3° C./min, more preferably 0.01° C./min to 1° C./min. The cooling process can be carried out by two steps or more in accordance with the progress of the volume shrinkage of the polymer in the core part in changing the temperature toward the glass transition temperature Tg (° C.). In that case, it is preferable to set a high cooling speed just after polymerization and then gradually reduce the cooling speed.

The preform after the above described processes has uniform refractive index distribution and sufficient optical transparency. In addition, the amount of the bubbles and macroscopic void decreases. The flatness of the interface between the clad part (or the inner clad part) and the core part becomes excellent. Although the above manufacture method describes the cylindrical preform with a single inner clad layer, the inner clad part having two or more layers may be formed. After the optical fiber is manufactured by the interfacial gel polymerization and the drawing processes, the inner clad part may be integrated with the core part.

Various kinds of the plastic optical members can be manufactured by processing the preform. For instance, slicing the preform in the direction perpendicular to the longitudinal direction can manufacture disk-shaped or cylindrical shaped lenses with flat surfaces. The POF can be manufactured by melt-drawing the preform. When the core part of the preform has refractive index profile, the POF with uniform optical transmittance can be stably manufactured with high productivity.

(Third Process)

In the melt-drawing process 13 as the third process, the preform is heated during the passage through a heating chamber (cylindrical heating chamber, for example), and the molten preform is drawn. The heating temperature can be determined in accordance with the material of the preform. In general, the heating temperature is preferably 180° C. to 250° C. The drawing condition (such as the drawing temperature) can be determined in accordance with the materials and the diameter of the POF. In forming the GI type POF having the refractive index profile in the core part, it is necessary to carry out the heating and drawing processes evenly in the radial direction of the POF, in order not to destroy the refractive index profile. Thus, the cylindrical heater capable of heating the preform uniformly over the section thereof is preferably used for the heating process. The heating chamber preferably has a distribution in the temperature in the direction to draw the preform. In order to prevent to destroy the refractive index profile, the heating area in the preform is preferably as small as possible. In other words, it is preferable to carry out preheat process at the position upstream of the heating area, and to carry out cooling process at the position downstream of the heating area. The heating device for the heating process may be a laser device that can supply high energy in a small heating area.

The drawing apparatus for the drawing process preferably has a core position adjusting mechanism to keep the position of the core, in order to keep the circularity of the preform. It is possible to control the orientation of the polymer of the POF by adjusting the drawing condition, and thus possible to control the mechanical property (such as the bending quality), thermal shrinkage, and so forth.

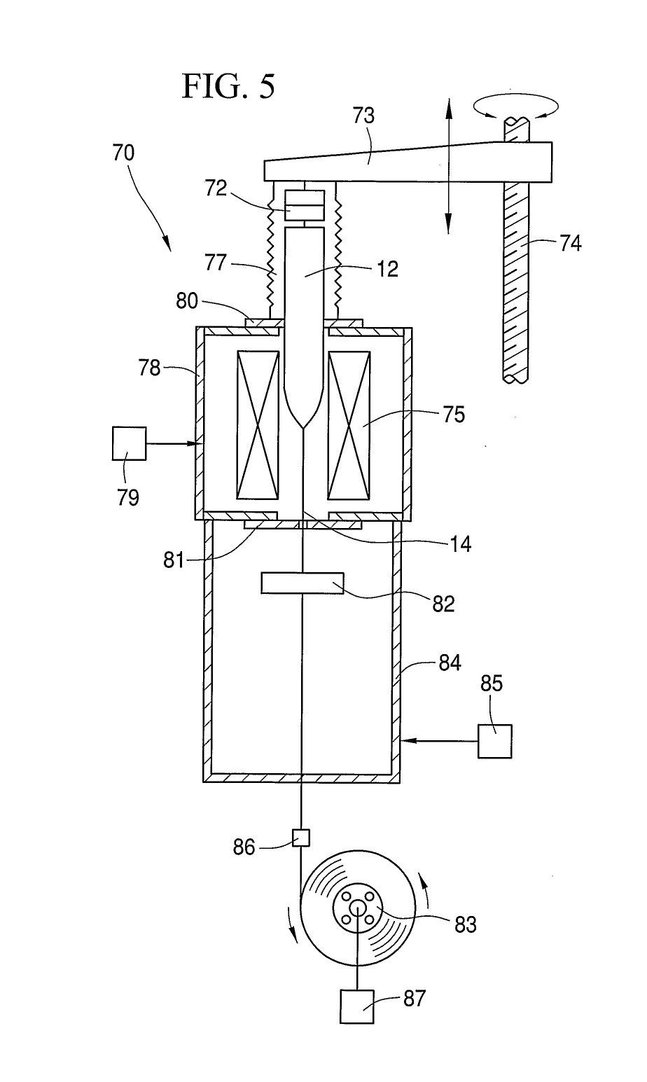

In FIG. 5, manufacture equipment 70 for manufacturing the POF 17 is illustrated. The preform 12 is supported by a vertical movement arm 73 (hereinafter referred to as “arm”) through an X-Y alignment device 72. The arm 73 is vertically movable by the rotation of a vertical movement screw 74 (hereinafter referred to as “screw”). Rotating the screw 74 at a constant speed in drawing the preform 12, the arm 73 is moved downward slowly (for example, 1 mm/min to 20 mm/min). Thereby, the lower end of the preform 12 enters a hollow cylindrical heating furnace 75. The preform 12 is melted and drawn little by little from the lower end thereof, and thus the POF 14 is manufactured. The whole surface of the preform 12 is preferably surrounded by a flexible cylinder 77 that shields the preform 12 from external dust and airflow for the purpose of keeping the atmosphere in the vicinity of the preform 12 before the heating process. The flexible cylinder 77 having the upper end portion of a dead-end structure is preferable because of reducing an updraft from the heating furnace 75.

The heating furnace 75 is stored in a heating furnace chamber 78 to keep the heating furnace 75 from external atmosphere. Thereby, it is possible to keep the atmosphere in the area to pass the preform 12. In addition, it is also preferable to provide a clean gas supply device 79 to make a clean condition in the heating furnace chamber 78.

For the purpose of keeping the quality of the polymer, it is preferable to keep the heating furnace 75 in an inert gas atmosphere. As for the gas to be supplied to the heating furnace 75, nitrogen gas (thermal conductivity: 0.0242 W/(m·K)) and rare gas such as helium gas (thermal conductivity: 0.1415 W/(m·K)), argon gas (thermal conductivity: 0.0015 W/(m·K)) and neon gas. In terms of the manufacture cost, nitrogen gas is preferably used. In terms of thermal conductivity, helium gas is preferable. Mixture gas, such as mixture gas of helium and argon, is preferable in obtaining the desirable thermal conductivity and reducing the manufacture cost. Inactive gas may be circulated because inactive gas is supplied for the purpose of keeping the heating furnace in an inactive gas atmosphere and controlling the thermal conductivity in the heating furnace 75. Circulating inactive gas can decrease the manufacture cost. The preferable supply of inactive gas depends on the heating condition and the kind of the gas to be supplied. As for helium gas, the supply is preferably 1 L/min to 10 L/min (in a room temperature).

In order to shield the heating furnace chamber 78 from external atmosphere, the entrance and the exit of the heating furnace chamber 78 for passing the preform and the POF is preferable shielded, if possible. Thus, the entrance and the exit of the heating furnace chamber 78 are preferably provided with a pair of shutters 80, 81. Opening and closing the shutters 80, 81 can reduce the gap in the entrance and the exit of the heating furnace chamber 78. Instead of the shutters 80, 81, the entrance and the exit may be shielded by a material with excellent heat resistance and friction property.

The diameter of the manufactured POF 14 is measured by use of a diameter measure device 82. Based on the measured diameter, the descending speed of the arm 73, the heating temperature of the heating furnace 75, the drawing speed of the POF 14, and so forth, are controlled such that the diameter of the POF 14 becomes a set value. In order to decrease the transmission loss caused by fluctuation in the diameter of the POF, the control system for controlling the diameter is preferably fast-responsive. In the manufacture equipment 70 of FIG. 5, the diameter of the POF 14 is controlled by adjusting the winding speed of a winding reel 83. It is also possible to control the diameter by controlling other parts in the manufacture equipment 70. For instance, when the preform is heated by use of a fast-response heating device such as a laser device, the heating energy of the laser device may be controlled.

The atmosphere in the drawing process and the winding process are required to be as clean as possible. Dust in the atmosphere will cause unevenness of the drawn preform 12, and the dust adhered on the molten preform 12 becomes a swelling. For the purpose of keeping the evenness and optical property of the POF 14, a clean box 84 is preferably provided in the atmosphere of the POF 14. The clean box 84 is connected to a clean gas inflow device 85 for flowing clean gas into the clean box 84. Thereby, it is possible to keep the cleanliness in the clean box 84. The cleanliness in the clean box 84 is preferably Class 10000 or smaller, and more preferably Class 3000 or smaller. Although not illustrated in FIG. 5, the clean gas inflow device 85 is preferably provided with an air circulation device to circulate the clean air and remove dust through a HEPA filter.

The POF 14 is wound around the winding reel 83. The tension to wind the POF 14 is preferably controlled by a tension measurement device 86 and a reel drive mechanism 87.

As described in JP-A No. 7-234322, the tension in the drawing process (drawing tension) is preferably 0.098 N or more. In order not to leave distortion in the POF 14 after the melt-drawing process, the drawing tension is preferably 0.98 N or less, as described in JP-A No. 7-234324. Since the drawing tension changes in accordance with the diameter and the material for the POF, the drawing tension is not limited to the above conditions. It is possible to carry out preliminary heating process in the melt-drawing, as described in JP-A No. 8-106015. The bending and lateral pressure properties of the POF improve by setting the elongation break and the hardness of the manufactured POF, as described in JP-A No. 7-244220. Moreover, as described in JP-A No. 8-54521, the transmission property of the POF improves by providing a low refractive index layer as the reflection layer around the POF.

[Protective Layer Material]

The material for the protective layer is selected such that the formation of the protective layer does not cause thermal damage (deformation, denaturation, thermal decompression, or the like) to the POF. Thus, the protective layer material should be hardened in reaction at a temperature between (Tg−50) ° C. and the glass transition temperature Tg (° C.) of the polymer for the POF. For the purpose of reducing the manufacture cost, the formation period (the period to harden the protective layer material) is preferably between 1 second and 10 minutes, and more preferably between 1 second and 5 minutes. When the POF is composed of plural polymers, Tg is the smallest glass transition temperature among these polymers. When the glass transition temperature Tg is less than the room temperature (for instance, the glass temperature of PVDF is about −40° C.), or when the polymers for POF do not have glass transition temperature, Tg is other phase transition temperature (melting point, for instance).

Examples of the material for the protective layer are ordinary olefin polymers such as polyethylene (PE) and polypropylene (PP), all-purpose polymer such as vinyl chloride and Nylon. It is also possible to apply the following materials that are effective in providing mechanical property (such as bending property) due to high elasticity. Examples of such materials are rubbers as the polymer, such as isoprene rubbers (for example, natural rubber and isoprene rubber), butadiene rubbers (for example, styrene-butadiene copolymer rubber and butadiene rubber), diene special rubbers (for example, nitrile rubber and chloroprene rubber), olefin rubbers (for example, ethylene-propylene rubber, acrylic rubber, butyl rubber and halide butyl rubber), ether rubbers, polysulfide rubbers and urethane rubbers.

The material for the protective layer may be a liquid rubber that exhibits fluidity in a room temperature and becomes solidified by application of heat. Examples of the liquid rubber are polydiene rubbers (basic structure is polyisoprene, polybutadiene, butadiene-acrylonitril copolymer, polychloroprene, and so forth), polyorefin rubbers (basic structure is polyorefin, polyisobutylene, and so forth), polyether rubbers (basic structure is poly(oxypropylene), and so forth), polysulfide rubbers (basic structure is poly(oxyalkylene disufide), and so forth) and polysiloxane rubbers (basic structure is poly(dimethyl siloxane), and so forth).

More preferably, the material for the protective layer is thermoplastic resin such as the polymer of ethylene, propylene and α-olefin. Examples of such polymer are ethylene homopolymer, ethylene-α-olefin copolymer, ethylene-propylene copolymer, and so forth. It is also possible to use a master batch in which metal hydration product and inflammable material (such as phosphorus and nitrogen) are added to these thermoplastic resins. The molecular weight (for example, number-average molecular weight and weight-average molecular weight) and the molecular weight distribution of the thermoplastic resin are not limited. But in terms of coating the plastic optical fiber with the thermoplastic resin, the thermoplastic resin with high fluidity is preferable. As for an index of the fluidity of resin, it is possible to use the melt flow rate (MFR) under the flow test (JIS K 7210 1916). The thermoplastic resin preferably has the MFR of 5 g/10 min to 150 g/10 min, the bending elastic ratio of 80 MPa to 400 MPa, and the melting temperature of 130° C. or lower. It is more preferable that the MFR is 20 g/10 min to 90 g/10 min, the bending elastic ratio of 100 MPa to 300 MPa, and the melting temperature of 125° C. or lower. The melting point Tm (° C.) of the thermoplastic resin used in this embodiment is preferably 135° C. or lower, more preferably 100° C. to 130° C., and most preferably 115° C. to 125° C. The temperature in the coating process is preferably 140° C. or lower, and more preferably 130° C. or lower.

As for the material of the protective layer, thermoplastic elastomer (TPE) can be used as well. The thermoplastic elastomer exhibits rubber elasticity at a room temperature, and becomes plasticized at a high temperature so that the thermoplastic elastomer is appropriate for easy molding. Examples of the thermoplastic elastomer are styrene thermoplastic elastomers, olefin thermoplastic elastomers, vinyl chloride thermoplastic elastomers, urethane thermoplastic elastomers, ester thermoplastic elastomers, amide thermoplastic elastomers, and so forth. Other materials than those described above can be used as long as the coating layer is formed at a temperature of equal to or less than the glass transition temperature Tg (° C.) of the POF polymer. For example, it is possible to use copolymer and mixed polymer of the above described materials or other materials.

As for the layer other than the protective layer, the material obtained by thermal hardening of the mixed liquid of a polymer precursors and reaction agent is preferably used. An example of such material is one-pack type thermosetting urethane composition produced from NCO block prepolymer and powder-coated amine, as described in JP-A No. 10-158353. Another example is one-pack type thermosetting urethane composition that is composed of urethane pre-polymer with NCO group, described in WO 95/26374, and solid amine having the size of 20 μm or smaller. For the purpose of improving the properties of the primary protective layer, additives and fillers may be added. Examples of the additives are incombustibility, antioxidant, radical trapping agent, lubricant. The fillers may be made from organic and/or inorganic compound.

[Method for Forming Protective Layer]

The method to form the protective layer is explained with reference to the drawings. The coating apparatus may be connected with the drawing apparatus for performing the coating process simultaneously or just after the drawing process.

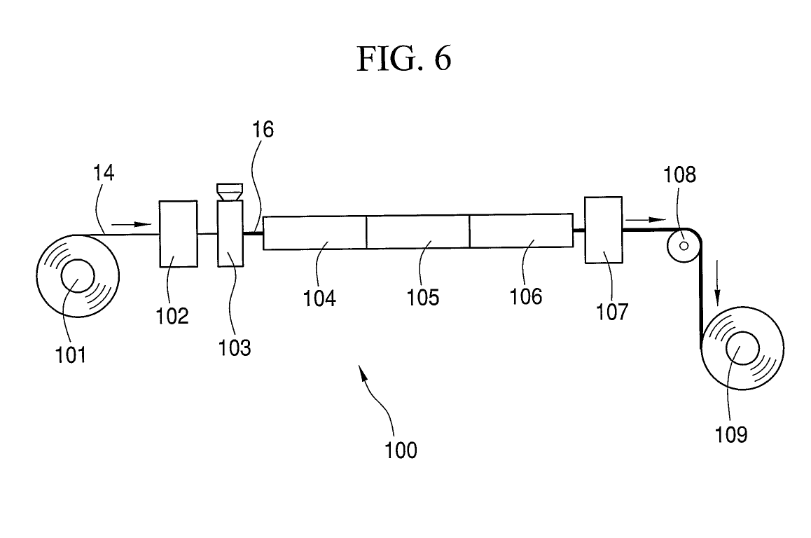

In FIG. 6, a coating line 100 for forming the protective layer around the plastic optical fiber (POF) 14 is illustrated. A well-known coating line for coating an electric cable and a glass optical fiber may be used as the coating line 100 according to this embodiment. The POF 14 is fed from a feeder 101 to the cooler device 102 for cooling the POF 14 to the temperature of 5° C. to 35° C. Cooling the POF 14 before forming the protective layer is preferable in terms of reducing thermal damage in the coating process, but the coating line 100 may not include the cooler device 102. Thereafter, a coating device 103 coats the thermoplastic resin (coating material) around the POF 14 to manufacture the plastic optical fiber strand (optical fiber strand) 16. The coating process will be explained later.

It is preferable that the optical fiber strand 16 is gradually cooled through first to third water tanks 104, 105, 106. When the melting temperature of polyethylene as the thermoplastic resin is 120° C. to 130° C., and when the feeding speed thereof is 20 m/min to 50 m/min, the preferable temperatures in the first, second and third water tanks 104, 105, 106 are 40° C. to 80° C., 20° C. to 50° C., and 5° C. to 20° C., respectively. The period to pass each of the water tanks 104-106 is preferably 0.1 min to 0.2 min. These numerical ranges do not limit the present invention. The number of the water tanks may be changed accordingly. Two to six water tanks are preferable, more preferably three to five water tanks, and most preferably three or four water tanks.

The optical fiber strand 16 is fed to a dehydrate machine 107 to remove water on the surface of the optical fiber strand 16. The optical fiber strand 16 is fed to a winding machine 109 via a feeding roller 108. Although the coating line 100 in FIG. 6 supplies the POF 14 from the feeding machine 101, the coating line 100 is not limited to the one illustrated in FIG. 6. For example, the coating line may include the manufacture equipment 70 (see FIG. 5) for manufacturing the POF 14. In that case, the manufacture equipment 70 continuously supplies the POF 14, and then the POF 14 is continuously coated with the coating material.

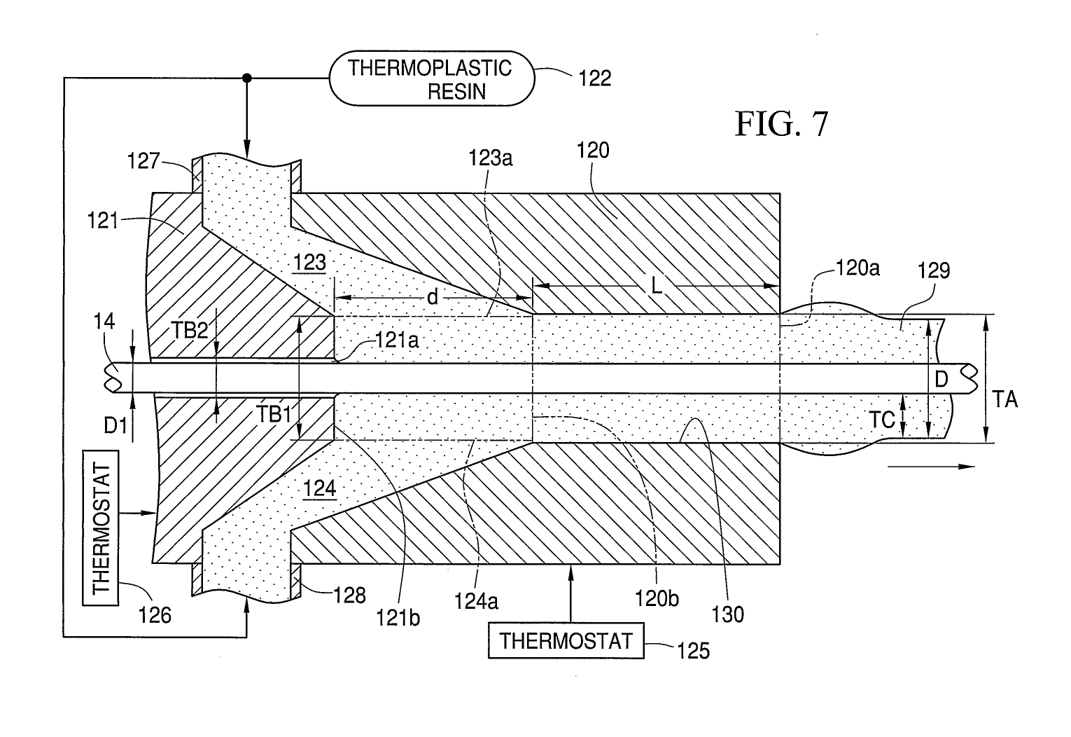

In FIG. 7, a die 120 and a nipple 121 provided in the coating apparatus 103 are illustrated. In the coating apparatus 103, the nipple 121 is fitted into the die 120 such that the gap between the die 120 and the nipple 121 forms a resin passage 123, 124 for passing the thermoplastic resin 122 as the coating material.

For the purpose of keeping fluidity of the thermoplastic resin 122, there are thermostats 125, 126 each of which is provided with the die 120 and the nipple 121. The temperature (coating temperature) of the thermoplastic resin 122 in the coating process is preferably as low as possible for the purpose of reducing the amount of heat transferred to the POF 14. For example, the coating temperature of polyethylene as the coating material is preferably 140° C. or lower, and more preferably 130° C. or lower. The lower limit of the coating temperature TD (° C.) is not limited, but the lower limit of the coating temperature must be the temperature to keep fluidity of the thermoplastic resin 122. Thus, the coating temperature TD of the thermoplastic resin 122 is preferably Tm (° C.) to (Tm+30) ° C., more preferably Tm (° C.) to (Tm+20) ° C., and most preferably Tm (° C.) to (Tm+10) ° C. It is to be noted that Tm (° C.) indicates the melting point of the thermoplastic resin 122. When the thermoplastic resin 122 is low density polyethylene having the melting point of 120° C., for example, the coating temperature is preferably 120° C. to 130° C. The POF 14 is passed through the fiber passage formed in the nipple 121, and fed outside the nipple 121 via an outlet opening 121a. Since the thermoplastic resin 122 comes in contact with the POF 14 with certain pressure, it is possible to improve the adhesion of the protective layer to the POF 14.

The shape of the POF 14 is not limited, but the diameter of the POF 14 is preferably 200 μm to 800 μm, and more preferably 300 μm to 750 μm. Although the feeding speed of the POF 14 is not limited, the feeding speed is preferably 10 m/min to 100 m/min. The feeding speed of lower than 10 m/min causes to get the productivity worse, and thus to increase the manufacture cost. Moreover, since the period to pass the fiber passage in the heated nipple 121 becomes longer, the POF 14 may be thermally damaged by the heat transferred from the nipple 121. On the other hand, the feeding speed of faster than 100 m/min will lose adhesiveness to the thermoplastic resin 122 as the coating material, and thus causes problems such as separation of the thermoplastic resin 122 and variation of the mechanical property because of crystallization of the resin.

The gap between the die 120 and the nipple 121 constitutes the resin passage 123, 124. The thermoplastic resin 122 with fluidity is heated at a predetermined temperature, and flown to the resin passage 123, 124 from the resin inlet 127, 128. The molten thermoplastic resin 122 through the resin passage 123, 124 is flown out toward the POF 14 via a resin outlet 123a, 124a. The thermoplastic resin 122 is coated on the outer surface of the POF 14 as the protective layer 129. Thereby, the optical fiber strand 16 having the protective layer 129 around the POF 14 is manufactured.

The POF 14 with the protective layer 129 is fed outside of the die 120 through the die exit 120a. The edge of the resin outlet 123a, 124a in the side of the die exit 120a is referred to as a land start position 120b. The tubular portion from the land start position 120b to the die exit 120a (hereinafter referred to as a land portion 130) is cylindrical hollow to pass the POF 14 with the thermoplastic resin 122. The length L (μm) indicates the length of the land portion 130 in the direction to feed the POF 14. The length d (μm) of the resin outlet 123a, 124a in the direction to feed the POF 14 indicates the distance from the nipple edge 121b to the land start position 120b. In this embodiment, the land portion 130 is formed in the die 120 such that the coating process of the POF 14 proceeds inside the die 120. Thereby, it is possible to diffuse the heat of the thermoplastic resin 122 to be transferred to the POF 14 during the coating process.

Adjusting the shape and the position of the die 120 and the nipple 121 makes it possible to decrease transmission loss caused by the thermal damage of the POF 14.

In FIG. 7, TA (μm) indicates the diameter of the hollow portion of the die 120, TB1 (μm) indicates the outer diameter of the nipple 121, TB2 (μm) indicates the inner diameter of the nipple 121, and D (μm) is the diameter of the optical fiber strand 16. It is preferable to satisfy the condition of D≦TA≦(1.3×D), more preferably (1.05×D)≦TA≦(1.25×D), and most preferably (1.1×D)≦TA≦(1.2×D). When the diameter TA is too large, larger elongation stress is applied to the POF 14, and thus the transmission loss will increase.

As for the length L (μm) of the land portion 130, it is preferable to satisfy the condition of TA≦L≦(4.0×TA), more preferably TA≦L≦(3.5×TA), and most preferably TA≦L≦(3.0×TA). When the length L of the land 130 is large, the POF 14 is deformed (stretched, for example) due to increase in the back pressure of the thermoplastic resin 122. Thus, the transmission loss will increase.

As for the outer diameter TB1 (μm) of the nipple 121, it is preferable to satisfy the condition of (0.7×TA)≦TB1≦(1.2×TA), more preferably (0.8×TA)≦TB1≦(1.2×TA), and most preferably (0.9×TA)≦TB1≦(1.1×TA). When the outer diameter TB1 of the nipple is large, it is difficult to narrow the gap between the die 120 and the nipple 121. In that case, since the POF 14 is stretched during the coating process, the transmission loss will increase.

The inner diameter TB2 of the nipple 121 is preferably (D1+10) μm to (D1+300) μm, and more preferably (D1+20) μm to (D1+50) μm, and most preferably (D1+30) μm to (D1+50) μm. A large inner diameter TB2 increases deviation in the center of the POF 14, and thus the transmission loss will increase due to unevenness of the side pressure to the POF 14.

As for the clearance d (μm), it is preferable to satisfy the condition of (1.0×TA)≦d≦(2.0×TA), more preferably (1.1×TA)≦d≦(1.8×TA), and most preferably (1.2×TA)≦d≦(1.6×TA). A large clearance d will stretch the POF 14 in the process to coat the thermoplastic resin 122. By adjusting these values, it is possible to form the protective layer 129 having a large thickness (400 μm to 1000 μm, for example).

By use of the die 120 and the nipple 121, it is possible to coat the thermoplastic resin 122 on the POF 124 easily, and to prevent the problem such as thermal damage to the POF 14 and improper formation of the protective layer. The diameter D1 (μm) of the POF 14 is preferably 200 μm to 800 μm, and more preferably 300 μm to 750 μm. The thickness TC (μm) of the protective layer 129 is preferably 100 μm to 1000 μm, more preferably 200 μm to 800 μm, and most preferably 400 μm to 600 μm.

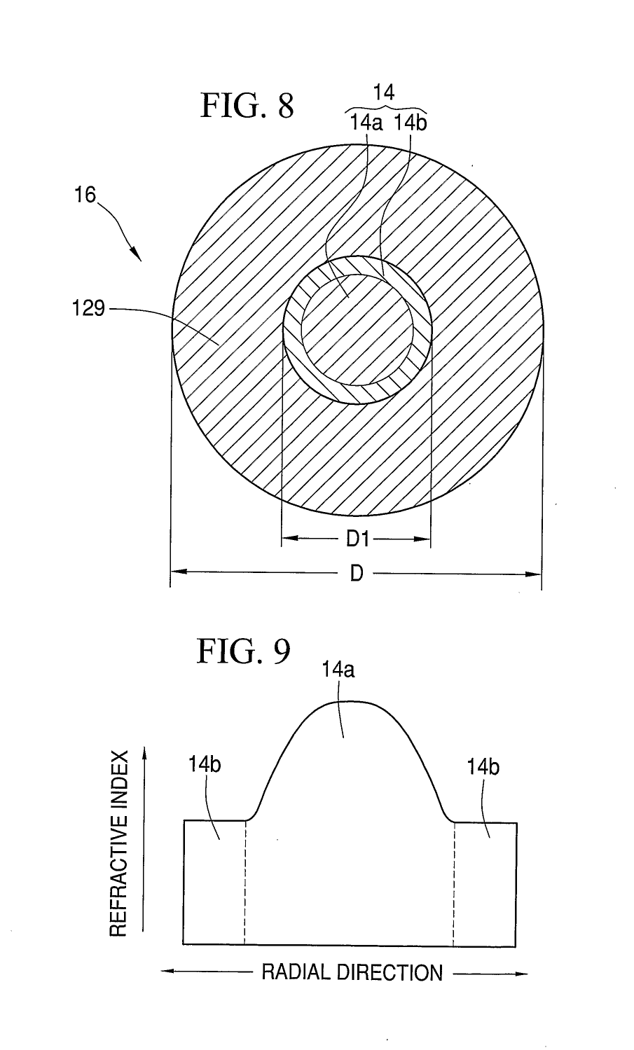

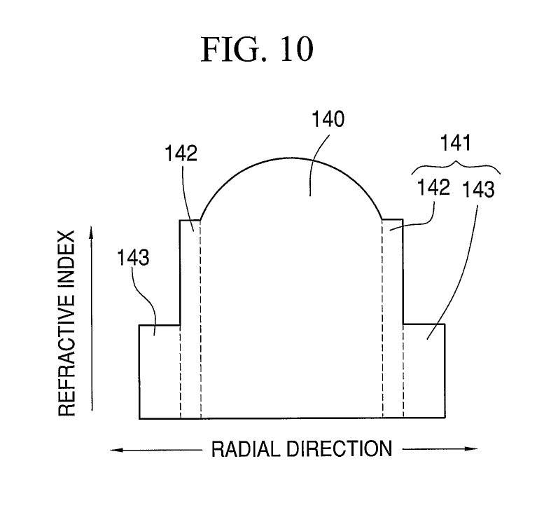

FIG. 8 shows the cross section of the optical fiber strand 16. The core part 14a in the center of the optical fiber strand 16 is covered with the clad part 14b. The protective layer 129 is formed around the clad part 14b. The refractive index profile of the POF 14 is shown in FIG. 9. The graph in FIG. 9 shows that the refractive index in the core part 14a takes the largest value in the center thereof, and gradually decreases with approximate square of the distance from the center. Since the refractive index in the clad part 14b is smaller than that in the core part 14a, the signal light can pass through the core part 14a due to the complete reflection at the interface between the core part 14a and the clad part 14b. The core part 14a is preferably PMMA and deuterium PMMA. A graded index type POF having such refractive index profile can be formed by the preform formed according to the first embodiment.

In FIG. 10, another example of the refractive index profile of the POF is shown. The clad part 141 is constituted of an inner clad part 142 and an outer clad part 143. The refractive index in the core part 140 takes the largest value in the center thereof, and gradually decreases with approximate square of the distance from the center. The outer clad part 143, having a lower refractive index than the core part 140, is formed around the inner clad part 142 for the purpose of complete reflection of the signal light in the core part 140. A graded index type POF having such refractive index profile can be formed by the preform formed according to the second embodiment.

The POF may be the multi-step type (MSI type) in which the refractive index takes the largest value at the center and decreases step by step according to the distance from the center. The step index type (SI type) optical fiber and the single mode type (SM type) optical fiber are also applicable.

[Structure of the Coating]

The plastic optical fiber cable (optical fiber cable) is manufactured by coating the POF and/or the optical fiber strand. For instance, the optical fiber cable 18 is manufactured in the second coating process 17 by use of the POF strand 16. As for the type of coating, there are a contact type coating in which the coating layer contacts the whole surface of the POF, and a loose type coating in which a gap is provided between the coating layer and the POF. When the coating layer of the loose type is peeled for attaching a connector, moisture enters the gap between the POF and the coating layer and extends in the longitudinal direction of the optical fiber cable. Thus, the contact type coating is preferable.

The loose type coating, however, has the advantage in relaxing the damages caused by stress and heat to the optical fiber cable due to the gap between the coating layer and the POF. Since the damage to the POF decreases, the loose type coating is preferably applied to some purposes. It is possible to shield moisture from entering from the lateral edge of the optical fiber cable by filling gelled or powdered material in the gap. If the gelled or powdered material as the filler is provided with the function of improving heat-resistance and mechanical strength, the coating layer with excellent properties can be realized. The loose type coating layer can be formed by adjusting the position of the extrusion nipple of the cross head die, and by controlling the pressure in a decompression device. The thickness of the gap layer between the POF and the coating layer can be controlled by adjusting the thickness of the nipple and pressure to the gap layer.

The outermost layer may contain the additives such as incombustibility, antioxidant, radical trapping agent and lubricant. Moreover, these additives may be contained in the first protective layer, formed in the first coating process 15, as long as the optical properties of the first protective layer are not affected.

The flame retardants are resin with halogen like bromine, an additive and a material with phosphorus. Metal hydroxide is preferably used as the flame retardant for the purpose of reducing toxic gas emission. The metal hydroxide contains water of crystallization, which is not removed during the manufacture of the POF. Thus, the inflammable layer including metal hydroxide is preferably formed as the outermost layer.

The POF may be coated with plural coat layers with multiple functions. Examples of such coat layers are a flame retardant layer described above, a barrier layer to prevent moisture absorption, moisture absorbent (moisture absorption tape or gel, for instance) between the protective layers or in the protective layer, a flexible material layer and a styrene forming layer as shock absorbers to relax stress in bending the POF, a reinforced layer to increase rigidity. The thermoplastic resin as the coat layer may contain structural materials to increase the strength of the optical fiber cable. The structural materials are a tensile strength fiber with high elasticity and/or a metal wire with high rigidity.

Examples of the tensile strength fibers are an aramid fiber, a polyester fiber, a polyamid fiber. Examples of the metal wires are stainless wire, a zinc alloy wire, a copper wire. The structural materials are not limited to those listed above. It is also possible to provide other materials such as a metal pipe for protection, a support wire to hold the optical fiber cable. A mechanism to increase working efficiency in wiring the optical fiber cable is also applicable.

In accordance with the way of use, the POF is selectively used as a cable assembly in which the POFs are circularly arranged, a tape core wire in which the POFs are linearly aligned, a cable assembly in which the tape core wires are bundled by using a band or LAP sheath, or the like.

Compared with the conventional optical fiber cable, the optical fiber cable containing the POF according to the present invention has large permissible error in the core position, the optical fiber cables may be connected directly. But it is preferable to ensure to fix the end of the POF as the optical member according to the present invention by using an optical connector. The optical connectors widely available on the market are PN type, SMA type, SMI type and the like.

[Optical Transmission System]

A system to transmit optical signals through the POF, the optical fiber wire and the optical fiber cable as the optical member comprises optical signal processing devices including optical components, such as a light emitting element, a light receiving element, an optical switch, an optical isolator, an optical integrated circuit, an optical transmitter and receiver module, and the like. Such system may be combined with other POFs. Any know techniques can be applied to the present invention. The techniques are described in, for example, “‘Basic and Practice of Plastic Optical Fiber’ (issued from NTS Inc.)”, “‘Optical members can be Loaded on Printed Wiring Assembly, at Last’ in Nikkei Electronics, vol. Dec. 3, 2001”, pp. 110-127”, and so on. By combining the optical member according to with the techniques in these publications, the optical member is applicable to short-distance optical transmission system that is suitable for high-speed and large capacity data communication and for control under no influence of electromagnetic wave. Concretely, the optical member is applicable to wiring in apparatuses (such as computers and several digital apparatuses), wiring in trains and vessels, optical linking between an optical terminal and a digital device and between digital devices, indoor optical LAN in houses, collective housings, factories, offices, hospitals, schools, and outdoor optical LAN.

Further, other techniques to be combined with the optical transmission system are disclosed, for example, in “‘High-Uniformity Star Coupler Using Diffused Light Transmission’ in IEICE TRANS. ELECTRON., VOL. E84-C, No. 3, MARCH 2001, pp. 339-344”, “‘Interconnection in Technique of Optical Sheet Bath’ in Journal of Japan Institute of Electronics Packaging., Vol. 3, No. 6, 2000, pp. 476-480”. Moreover, there are am optical bus (disclosed in Japanese Patent Laid-Open Publications No. 10-123350, No. 2002-90571, No. 2001-290055 and the like); an optical branching/coupling device (disclosed in Japanese Patent Laid-Open Publications No. 2001-74971, No. 2000-329962, No. 2001-74966, No. 2001-74968, No. 2001-318263, No. 2001-311840 and the like); an optical star coupler (disclosed in Japanese Patent Laid-Open Publications No. 2000-241655); an optical signal transmission device and an optical data bus system (disclosed in Japanese Patent Laid-Open Publications No. 2002-62457, No. 2002-101044, No. 2001-305395 and the like); a processing device of optical signal (disclosed in Japanese Patent Laid-Open Publications No. 2000-23011 and the like); a cross connect system for optical signals (disclosed in Japanese Patent Laid-Open Publications No. 2001-86537 and the like); a light transmitting system (disclosed in Japanese Patent Laid-Open Publications No. 2002-26815 and the like); multi-function system (disclosed in Japanese Patent Laid-Open Publications No. 2001-339554, No. 2001-339555 and the like); and various kinds of optical waveguides, optical branching, optical couplers, optical multiplexers, optical demultiplexers and the like. When the optical system having the optical member according to the present invention is combined with these techniques, it is possible to construct an advanced optical transmission system to send/receive multiplexed optical signals. The optical member according to the present invention is also applicable to other purposes, such as for lighting, energy transmission, illumination, and sensors.

### EXPERIMENTS

The present invention will be described in detail with reference to Experiments (1)-(4) as the embodiments of the present invention and Experiments (5)-(8) as the comparisons. The materials, contents, operations and the like will be changed so far as the changes are within the spirit of the present invention. Thus, the scope of the present invention is not limited to the Experiments described below. The description below explains Experiment (1) in detail. Regarding Experiments (2)-(8), the portions different from Experiment (1) will be explained.

In Experiment (1), the protective layer is formed around the POF by use of an extruder (diameter φ of the screw: 30 mm) to which a mold having the die and the nipple is attached. The diameter TA and the land portion length L of the die are 1200 μm and 1500 μm, respectively. The clearance d is 1500 μm. The outer diameter TB1 and the inner diameter TB2 of the nipple are 1300 μm and 850 μm, respectively. Low density polyethylene (LDPE; Nipolon-L manufactured by Tosoh Corp.; MFR=50 g/10 min) as the coating material is extruded from the extruder under the condition of 130° C. and 13.2 g/min. While the plastic optical fiber having the diameter of 750 μm is fed at the speed of 20 m/min, the coating material is contacted to the plastic optical fiber in the die such that the diameter of the coated POF becomes 1200 μm. After coating the thermoplastic resin, the POF is passed through the first water tank (temperature: 60° C.) for 10 seconds. Thereafter, the POF is fed through the second water tank (temperature: 30° C.) for 10 seconds. Then, after passing through the third water tank (temperature: 10° C.) for 10 seconds and removing moisture, the plastic optical fiber is wound around the bobbin. The transmission loss of the coated plastic optical fiber is measured, and increase in the transmission loss after forming the protective layer is 0.5 dB/km. The force to pull the fiber strand out of the coated optical fiber (30 mm) at the speed of 100 m/min is 5 (N), so the plastic optical fiber exhibits excellent adhesiveness. In addition, the hardness of the coated optical fiber (measured by the displacement at weight under the standard of JIS C6851) is excellent as 3.00×10⁻⁴ (N·m²).

In Experiment (2), the diameter TA and the land portion length L of the die are 2300 μm and 3500 μm, respectively. The outer diameter TB1 and the inner diameter TB2 of the nipple are 2200 μm and 850 μm, respectively. The clearance d is 3000 μm. Low density polyethylene (LDPE; Nipolon-L manufactured by Tosoh Corp.; MFR=50 g/10 min) as the coating material is extruded from the extruder under the condition of 130° C. and 64.1 g/min. While the plastic optical fiber having the diameter of 750 μm is fed at the speed of 20 m/min, the coating material is contacted to the plastic optical fiber in the die such that the diameter of the coated POF becomes 2200 μm. After coating the thermoplastic resin, the plastic optical fiber is cooled under the same condition as Experiment (1). Then, after removal of moisture, the plastic optical fiber is wound around the bobbin. The transmission loss of the coated plastic optical fiber is measured, and the increase in the transmission loss after forming the protective layer is 1.0 dB/km.

In Experiment (3), the diameter TA and the land portion length L of the die are 750 μm and 1000 μm, respectively. The outer diameter TB1 and the inner diameter TB2 of the nipple are 800 μm and 500 μm, respectively. The clearance d is 1000 μm. Low density polyethylene (LDPE; JMA07A manufactured by JPE; MFR=50 g/10 min) as the coating material is extruded from the extruder under the condition of 130° C. and 6.9 g/min. While the plastic optical fiber having the diameter of 316 μm is fed at the speed of 20 m/min, the coating material is contacted to the plastic optical fiber in the die such that the diameter of the coated POF becomes 750 μm. After coating the thermoplastic resin, the plastic optical fiber is cooled under the same condition as Experiment (1). Then, after removal of moisture, the plastic optical fiber is wound around the bobbin. The transmission loss of the coated plastic optical fiber is measured, and the increase in the transmission loss after forming the protective layer is 0.5 dB/km.

In Experiment (4), the diameter TA and the land portion length L of the die are 1400 μm and 2500 μm, respectively. The outer diameter TB1 and the inner diameter TB2 of the nipple are 1250 μm and 400 μm, respectively. The clearance d is 2000 μm. Low density polyethylene (LDPE; Nipolon-L manufactured by Tosoh Corp.; MFR=50 g/10 min) as the coating material is extruded from the extruder under the condition of 130° C. and 20.1 g/min. While the plastic optical fiber having the diameter of 316 μm is fed at the speed of 20 m/min, the coating material is contacted to the plastic optical fiber in the die such that the diameter of the coated POF becomes 1200 μm. After coating the thermoplastic resin, the plastic optical fiber is cooled under the same condition as Experiment (1). Then, after removal of moisture, the plastic optical fiber is wound around the bobbin. The transmission loss of the coated plastic optical fiber is measured, and the increase in the transmission loss after forming the protective layer is 0.0 dB/km.

In Experiment (5) as the comparison experiment, the nipple having the land portion is used. After extruding from the die, the tubular thermoplastic resin is contacted to the POF outside of the die, so that the coating layer is formed on the POF. In this experiment, the same condition as Experiment (1) is used except that the land portion length L of the nipple is 3000 μm. The transmission loss of the coated plastic optical fiber is measured, and the increase in the transmission loss after forming the protective layer is 30 dB/km. The force to pull the fiber strand out of the coated optical fiber (30 mm) at the speed of 100 m/min is 2 (N), which is less than the half of that in Experiment (1).

In Experiment (6), the diameter TA and the land portion length L of the die are 750 μm and 1000 μm, respectively. The outer diameter TB1 and the inner diameter TB2 of the nipple are 800 μm and 500 μm, respectively. The clearance d is 3000 μm. Low density polyethylene (LDPE; Nipolon-L manufactured by Tosoh Corp.; MFR=50 g/10 min) as the coating material is extruded from the extruder under the condition of 130° C. and 6.9 g/min. While the plastic optical fiber having the diameter of 316 μm is fed at the speed of 20 m/min, the coating material is contacted to the plastic optical fiber in the die such that the diameter of the coated POF becomes 750 μm. After coating the thermoplastic resin, the plastic optical fiber is cooled under the same condition as Experiment (1). Then, after removal of moisture, the plastic optical fiber is wound around the bobbin. The transmission loss of the coated plastic optical fiber is measured, and the increase in the transmission loss after forming the protective layer is 20.0 dB/km. The length of the plastic optical fiber after the coating process becomes longer by 2.0% compared with the length before the coating process. This is because the extrusion speed becomes smaller than the feeding speed due to the large clearance, and thus the resistance is applied to the fiber strand. Because the length of the POF increases, there is irregularity at the interface between the clad part and the core part, and thus the transmission loss increases.

In Experiment (7), the diameter TA and the land portion length L of the die are 2000 μm and 2500 μm, respectively. The outer diameter TB1 and the inner diameter TB2 of the nipple are 1250 μm and 400 μm, respectively. The clearance d is 2000 μm. Low density polyethylene (LDPE; JMA07A manufactured by JPE; MFR=50 g/10 min) as the coating material is extruded from the extruder under the condition of 130° C. and 20.1 g/min. While the plastic optical fiber having the diameter of 316 μm is fed at the speed of 20 m/min, the coating material is contacted to the plastic optical fiber in the die such that the diameter of the coated POF becomes 1200 μm. After coating the thermoplastic resin, the plastic optical fiber is cooled under the same condition as Experiment (1). Then, after removal of moisture, the plastic optical fiber is wound around the bobbin. The transmission loss of the coated plastic optical fiber is measured, and the increase in the transmission loss after forming the protective layer is 15.0 dB/km. Due to the large hole in the die, the thermoplastic resin extruded from the die is extended, and thus the stress is applied to the plastic optical fiber. Therefore, it is presumed that the transmission loss increases.

In Experiment (8), the diameter TA and the land portion length L of the die are 1300 μm and 2500 μm, respectively. The clearance d is 2000 μm. The outer diameter TB1 and the inner diameter TB2 of the nipple are 1250 μm and 400 μm, respectively. Low density polyethylene (LDPE; Nipolon-L manufactured by Tosoh Corp.; MFR=50 g/10 min) as the coating material is extruded from the extruder under the condition of 130° C. and 6.9 g/min. While the plastic optical fiber having the diameter of 316 μm is fed at the speed of 20 m/min, the coating material is contacted to the plastic optical fiber in the die such that the diameter of the coated POF becomes 1200 μm. After coating the thermoplastic resin, the POF is passed through the first water tank (temperature of 10° C.) for 10 seconds. Thereafter, the POF is fed through the second water tank (temperature of 10° C.) for 10 seconds. Then, after passing through the third water tank (temperature of 10° C.) for 10 seconds and removing moisture, the plastic optical fiber is wound around the bobbin. The transmission loss of the coated plastic optical fiber is measured, and the increase in the transmission loss after forming the protective layer is 20.0 dB/km. There are gaps in the optical fiber. Because the thermoplastic resin is rapidly cooled, the inner wall of the thermoplastic resin is shrunk outwardly, and thus it is presumed that the gaps are generated. Thereby, the stress to the POF strand becomes uneven, and the transmission loss increases.

These experiments show that the transmission loss does not increase by satisfying the conditions according to the present invention.

### INDUSTRIAL APPLICABILITY

The present invention relates to a method and an apparatus utilized in coating a surface of a plastic optical fiber.

1. A method for coating a thermoplastic resin on a plastic optical fiber that is fed through an die exit formed in a die and a fiber passage formed in a nipple, the nipple being partially inserted in the die, the thermoplastic resin being flown through a resin passage formed between the die and the nipple;
the edge of the nipple in the downstream side being located upstream of the die exit with respect to the feeding direction of the plastic optical fiber, and the plastic optical fiber being coated with the thermoplastic resin before reaching the die exit.

2. The method for coating according to claim 1, wherein the die has a tapered portion for constituting the resin passage together with the nipple, and a cylindrical land portion connected to the tapered portion and extending toward the die exit, the die satisfying the following conditions;
D≦TA≦1.3×D
TA≦L≦4.0×TA
wherein L (μm) denotes the length of the land portion, TA (μm) denotes the inner diameter of the die exit, and D (μm) denotes the diameter of the plastic optical fiber coated with the thermoplastic resin.

3. The method for coating according to claim 1, wherein the die and the nipple satisfy the following condition;
0.7×TA≦TB1≦1.3×TA
wherein TA (μm) denotes the inner diameter of the die exit, and TB1 (μm) denotes the outer diameter of the edge of the nipple.

4. The method for coating according to claim 1, wherein the nipple satisfies the following condition;
10 (μm)≦TB2−D1≦300 (μm)
wherein D1 (μm) denotes the diameter of the plastic optical fiber, and TB2 (μm) denotes the inner diameter of the fiber passage of the nipple.

5. The method for coating according to claim 2, wherein the length of the tapered portion in the feeding direction is between TA and 2×TA.

6. The method for coating according to claim 1, the diameter of the plastic optical fiber is 200 μm to 800 μm.

7. The method for coating according to claim 1, wherein the plastic optical fiber includes a core and a clad formed around the core, the core being formed from acrylic resin.

8. The method for coating according to claim 1, satisfying the following condition;
Tm≦TD≦(Tm+30)
wherein TD (° C.) is the temperature of the thermoplastic resin in coating on the plastic optical fiber, and Tm (° C.) is the melting point of the thermoplastic resin.

9. The method for coating according to claim 1, wherein the melting point of the thermoplastic resin is 130° C. or higher.

10. The method for coating according to claim 1, wherein the melt flow rate of the thermoplastic resin is 20 g/10 min or smaller.

11. The method for coating according to claim 1, further comprising the step of cooling the plastic optical fiber step by step after coating the thermoplastic resin.

12. An apparatus for coating a thermoplastic resin on a plastic optical fiber, the apparatus comprising:
a nipple in which an fiber passage for the plastic optical fiber is formed; and
a die in which the nipple is partially inserted and a die exit is formed, the thermoplastic resin being flown through a resin passage formed between the die and the nipple, the edge of the nipple in the downstream side being located upstream of the die exit with respect to the feeding direction of the plastic optical fiber, and the plastic optical fiber being coated with the thermoplastic resin before reaching the die exit.

13. The apparatus for coating according to claim 12, wherein the die has a tapered portion for constituting the resin passage together with the nipple, and a cylindrical land portion connected to the tapered portion and extending toward the die exit, the die satisfying the following conditions;
D≦TA≦1.3×D
TA≦L≦4.0×TA
wherein L (μm) denotes the length of the land portion, TA (μm) denotes the inner diameter of the die exit, and D (μm) denotes the diameter of the plastic optical fiber coated with the thermoplastic resin.

14. The apparatus for coating according to claim 12, wherein the die and the nipple satisfy the following condition;
0.7×TA≦TB1≦1.3×TA
wherein TA (μm) denotes the inner diameter of the die exit, and TB1 (μm) denotes the outer diameter of the edge of the nipple.

15. The apparatus for coating according to claim 12, wherein the nipple satisfies the following condition;
10 (μm)≦TB2−D1≦300 (μm)
wherein D1 (μm) denotes the diameter of the plastic optical fiber, and TB2 (μm) denotes the inner diameter of the fiber passage of the nipple.

16. The apparatus for coating according to claim 13, wherein the length of the tapered portion in the feeding direction is between TA and 2×TA.

17. The apparatus for coating according to claim 12, further comprising a cooling section for cooling the plastic optical fiber step by step after coating the thermoplastic resin.
